(19) United States
(12) Patent Application Publication
(10) Pub. No.: US 2025/0375780 A1
(43) Pub. Date: Dec. 11, 2025

(54) SPRAY GUN SYSTEM WITH RESILIENT FLOW CONTROL VALVE

(71) Applicant: 3M INNOVATIVE PROPERTIES COMPANY, St. Paul, MN (US)

(72) Inventors: Ryan D. Erickson, Roseville, MN (US); Bryan J. Hayward, St. Paul, MN (US); Stephen C.P. Joseph, Woodbury, MN (US); Scott D. Gullicks, River Falls, WI (US)

(21) Appl. No.: 18/877,233

(22) PCT Filed: Jun. 30, 2023
(86) PCT No.: PCT/IB2023/056876

§ 371 Date: Dec. 19, 2024

Related U.S. Application Data
(60) Provisional application No. 63/358,039, filed on Jul. 1, 2022.

(51) Int. Cl. B05B 1/30; B05B 7/06; B05B 7/24

(52) U.S. Cl. CPC B05B 1/3046; B05B 7/066; B05B 7/2424; B05B 7/2478

(57) ABSTRACT

Aspects of the present disclosure relate to a method that includes installing a resilient flow control valve within a portion of a liquid passageway formed in the spray gun system such that liquid is capable of being contained by the resilient flow control valve without leakage. A wettable needle chamber can be coaxial with a portion of the liquid passageway. The present disclosure may also relate to a kit that includes a resilient flow control valve configured to sealingly engage with a portion of a nozzle liquid passageway of a nozzle assembly or directly adjacent to the nozzle liquid passageway.

### BACKGROUND

Spray equipment is used in many processes including surface coating applications, combustion, and chemical reaction control. Spray equipment can include devices that transform bulk liquids into a fine spray or mist of droplets. The size and shape of spray equipment can depend upon the desired application and/or delivery system. Applications over the years have included delivery of gas hydrocarbon feeds in fluidized catalytic cracking processes, dispensing of chemical insecticides, and application of protective or aesthetic surface coatings.

Spray equipment can be used, for example, in vehicle repair body shops to apply liquid coating media such as primer, paint and/or clearcoat to vehicle parts. Spray equipment such as a spray gun can be made of combination of metal and polymeric materials and includes a platform and spray head assembly. The spray head assembly includes a nozzle for dispensing the liquid, one or more atomizing gas outlets to atomize the liquid as it exits the nozzle, and two or more shaping gas outlets to shape the atomized liquid into the desired spray pattern. The spray gun contains a series of internal passages that distribute gas from a gas supply manifold in the platform to the atomizing gas outlet(s) and shaping gas outlets in the spray head assembly. Such spray guns are sometimes referred to as the air-atomizing, air-spray, air-assist, or air-blast type.

### BRIEF SUMMARY

In some designs, manually-operated valves such as a needle valve are used to control the flow of coating liquid through the spray gun (see for example, FIG. 1, FIG. 2, and FIG. 3). The needle (or valve stem) is located along a central axis of the nozzle and shuts off on the valve seat (nozzle sealing surface) near the liquid outlet. The needle/stem is typically connected to a trigger as a means of actuation by the user's hand. When the trigger is pulled back by the user, the needle will slide away from the valve seat and allow liquid to flow through the passage outlet. When the trigger is released, a biasing mechanism (e.g., spring) is used to push the needle back to its closed position in contact with the valve seat. Along the length of the needle, seals (or packings) are used to isolate liquid within the flow passage from the external region of the spray gun.

These components found in the aforementioned spray gun system are known to use tight manufacturing tolerances, contribute appreciably to the cost of the spray gun, wear down over time due to cycling, and use routine cleaning and maintenance by the user.

Aspects of the present disclosure can relate to a modified needle assembly. The modified needle assembly can include a first shaft section having a first end. The first end is configured to be oriented toward a nozzle sealing surface of a spray gun system. The modified needle assembly can also include a second shaft section having a second end opposite the first end. The second shaft section is configured to fit in a non-wettable needle chamber of the spray gun system. The second end is configured to operably engage with components of the spray gun system and the first end is configured not to contact the nozzle sealing surface to form a needle-nozzle seal. The modified needle assembly has a needle length dimension that is less than a length dimension of a needle passageway of the spray gun system.

In at least one embodiment, the modified needle assembly can include a needle boss between the first shaft section and the second shaft section. The needle boss is configured to engage with a biasing mechanism, a poppet valve, and/or a trigger.

In at least one embodiment, the needle boss is crimped on.

In at least one embodiment, the first shaft section has a length dimension that is less than a conventional needle for the spray gun system. The first end is configured not to form a fluid-tight seal with the spray gun system.

In at least one embodiment, the second shaft section is configured to form a slidable fluid-tight seal with a packing seal.

In at least one embodiment, the first shaft section is configured to form a fluid-tight seal with a poppet valve. The poppet valve seals the needle chamber of the non-wettable needle chamber and engages with a trigger of the spray gun system.

In at least one embodiment, the poppet valve comprises a thru passageway from a poppet flange end to a poppet distal end.

In at least one embodiment, the poppet valve is configured to contact a biasing mechanism in the needle chamber of the non-wettable needle chamber.

In at least one embodiment, the modified needle assembly includes a sealing structure disposed on the first end of the first shaft section. The sealing structure is configured to form a fluid-tight seal with a portion of the needle passageway to separate the needle passageway into a wettable needle chamber and a non-wettable needle chamber.

In at least one embodiment, a needle boss is configured such that the needle boss does not engage with a trigger of the spray gun system when the modified needle assembly is assembled into the spray gun platform and the sealing structure forms a fluid-tight seal with the portion of the needle passageway.

In at least one embodiment, the second shaft section is configured to engage with a biasing mechanism.

Another aspect of the present disclosure relates to a kit. The kit can include a resilient flow control valve configured to sealingly engage within a portion of a nozzle liquid passageway of a nozzle assembly or directly adjacent to the nozzle liquid passageway. The nozzle assembly generally includes a nozzle gas inlet and a nozzle gas outlet forming an atomizing gas passageway therebetween and a nozzle liquid inlet and a nozzle liquid outlet forming the nozzle liquid passageway therebetween. The atomizing gas passageway is configured to be removably coupled to a gas passageway of a spray gun platform. The nozzle liquid passageway is configured to form a fluid-tight seal with a needle of the spray gun platform at a needle-nozzle seal of the nozzle assembly.

In at least one embodiment, the kit can include a spray gun platform which may be a conventional spray gun. The nozzle assembly can include a needle passageway that is coaxial with the entire nozzle liquid passageway.

In at least one embodiment, the nozzle assembly comprises an attachment structure on an outside surface configured to mate with a compatible attachment structure on the spray gun platform.

In at least one embodiment, a spray gun system comprises the spray gun platform and the nozzle assembly. The spray gun system comprises a needle passageway configured to allow a conventional needle to pass through both the spray gun platform and nozzle assembly.

In at least one embodiment, a portion of the nozzle liquid passageway is coaxial with the needle passageway.

In at least one embodiment, the entire liquid passageway is coaxial with the needle passageway.

In at least one embodiment, the needle passageway comprises a wettable needle chamber and a non-wettable needle chamber. A secondary opening leads into the wettable needle chamber. In at least one embodiment, a packing seal divides the wettable needle chamber from the non-wettable needle chamber.

In at least one embodiment, when the nozzle assembly is assembled with the spray gun platform and operating in a first mode, a differential pressure across the resilient flow control valve is less than an opening pressure of the resilient flow control valve and results in a closed configuration.

In at least one embodiment, in a second mode, gas flow from a spray gun system including the spray gun platform and the nozzle assembly causes the differential pressure across the resilient flow control valve to be at least the opening pressure of the resilient flow control valve and thereby causes the resilient flow control valve to change to an open configuration.

In at least one embodiment, the resilient flow control valve comprises a slit that is capable of forming an opening in the open configuration.

In at least one embodiment, the non-wettable needle chamber comprises a first needle chamber and a second needle chamber.

In at least one embodiment, the kit includes a sealing structure to seal the secondary opening of the spray gun platform or the nozzle assembly.

In at least one embodiment, the kit includes a sealing structure to fluidically separate the wettable needle chamber from the non-wettable needle chamber.

In at least one embodiment, the nozzle assembly is a nozzle cartridge, wherein the nozzle liquid passageway is formed between the nozzle liquid inlet, and the nozzle liquid outlet, and the wettable needle chamber is formed from a portion of the nozzle liquid passageway and between the nozzle liquid outlet and the secondary opening.

In at least one embodiment, the spray gun platform includes the non-wettable needle chamber formed therein. In at least one embodiment, the kit can include a poppet valve that is configured to (1) not allow the needle to pass thru, (2) slidably seal the non-wettable needle chamber, and (3) engage with a trigger of the spray gun platform.

In at least one embodiment, the kit can include the modified needle assembly described herein.

In at least one embodiment, the poppet valve can have a poppet inner diameter and a poppet outer seal. The modified needle assembly can be configured to form a slidable fluid-tight seal with the poppet inner diameter.

In at least one embodiment, the resilient flow control valve comprises a flange configured to form a fluid-tight seal with a rim proximate to an attachment structure of the nozzle assembly.

In at least one embodiment, the kit can include a frame structure between the resilient flow control valve and the nozzle assembly. The frame structure can be integral with the resilient flow control valve.

In at least one embodiment, the kit can include a liner assembly comprising a liner tube and a liner liquid inlet. The liner assembly is configured to contain liquid from the liner liquid inlet through a distal end of the liner tube. The resilient flow control valve is configured to form a fluid-tight seal with the liner assembly.

In at least one embodiment, the resilient flow control valve forms a single assembly with the liner assembly.

In at least one embodiment, the liner tube is configured to pass through and conform to portions of (1) the liquid passageway of the spray gun platform and/or (2) the nozzle liquid passageway of the nozzle assembly.

In at least one embodiment, the resilient flow control valve is attached to the distal end.

Aspects of the present disclosure relate to a method (e.g., of retrofitting a spray gun system, and/or nozzle assembly) that includes installing a resilient flow control valve within a portion of a liquid passageway formed in the spray gun system such that liquid is capable of being contained by the resilient flow control valve without leakage through the liquid outlet, the nozzle liquid outlet, and/or secondary opening. A wettable needle chamber (of the nozzle assembly) is coaxial with a portion of the liquid passageway.

In at least one embodiment, the method can include sealing a secondary opening, with a sealing structure, of a needle passageway formed in a spray gun system comprising a spray gun platform and a nozzle assembly. In at least one embodiment, the needle passageway is configured to allow a conventional needle to pass through both the spray gun platform and nozzle assembly. In at least one embodiment, the sealing forms a wettable needle chamber and a non-wettable needle chamber from the needle passageway. In at least one embodiment, sealing the secondary opening does not use the conventional needle.

In at least one embodiment, sealing the secondary opening of the needle passageway comprises inserting a liner assembly into a liquid inlet, through a portion of a liquid passageway, and toward a liquid outlet. In at least one embodiment, another portion of the liquid passageway is coaxial with the wettable needle chamber. In at least one embodiment, the liner assembly comprises a liner tube and a liner liquid inlet. The liner assembly is configured to contain liquid from the liner liquid inlet through a distal end of the liner tube. In at least one embodiment, the distal end of the liner tube has the resilient flow control valve installed thereon. In at least one embodiment, installing the resilient flow control valve comprises inserting the liner tube through the liquid passageway.

In at least one embodiment, sealing the secondary opening comprises inserting a sealing structure into the secondary opening and at least partially into the wettable needle chamber.

In at least one embodiment, the sealing structure is configured to attach to a body of the spray gun platform or a nozzle cartridge and fill in the secondary opening.

In at least one embodiment, the sealing structure is configured to fill in a majority of the wettable needle chamber.

In at least one embodiment, sealing the secondary opening comprises forming a wall over the secondary opening.

In at least one embodiment, installing the resilient flow control valve comprises positioning the resilient flow control valve such that when the spray gun system is operating in a first mode, a differential pressure across the resilient flow control valve is less than an opening pressure of the resilient flow control valve and results in a closed configuration.

In at least one embodiment, in a second mode, gas flow from a spray gun system including the spray gun platform and nozzle assembly causes the differential pressure across the resilient flow control valve to be at least the opening pressure of the resilient flow control valve and thereby causes the resilient flow control valve to change to an open configuration.

In at least one embodiment, the method can also include removing the nozzle assembly from the spray gun platform prior to sealing the secondary opening.

In at least one embodiment, the nozzle assembly is a nozzle cartridge that is removably coupled to the spray gun platform. The secondary opening is in the nozzle cartridge. In at least one embodiment, sealing the secondary opening comprises sealing the wettable needle chamber of the nozzle cartridge and installing the resilient flow control valve comprises installing the resilient flow control valve within a nozzle liquid passageway of the nozzle cartridge to form a valved nozzle cartridge. In at least one embodiment, the method can include installing the valved nozzle cartridge onto the spray gun platform.

In at least one embodiment, the nozzle assembly is a spray gun nozzle body having a nozzle liquid passageway that is completely aligned along the spray axis and a liquid inlet is configured to couple to a liquid outlet on the spray gun platform. The secondary opening is in the spray gun platform. In at least one embodiment, installing the resilient flow control valve comprises installing the resilient flow control valve within the nozzle liquid passageway of the spray gun nozzle body to form a valved fluid nozzle. In at least one embodiment, the method can include installing the valved fluid nozzle onto the spray gun platform.

In at least one embodiment, the method can include receiving the spray gun system which can include the spray gun platform, comprising the liquid inlet, the secondary opening, and the liquid outlet forming a liquid passageway therebetween.

In at least one embodiment, the method can include removing the conventional needle from the needle passageway.

In at least one embodiment, the method can include installing a modified needle assembly. The modified needle assembly does not form a needle-nozzle seal with the spray gun system. In at least one embodiment, a first end of modified needle assembly is at least 0.5 mm, or a dimension of the resilient flow control valve, from the resilient flow control valve when installed.

In at least one embodiment, sealing the portion of the needle passageway does not include the conventional needle.

In at least one embodiment, the method can include attaching pressurized air to a gas inlet of the spray gun system. In at least one embodiment, flow of the liquid through the liquid outlet stops through operation of the resilient flow control valve, and not a needle valve. Thus, a needle-nozzle seal is not formed.

Additional aspects of the present disclosure relate to a method. The method includes removing or modifying a conventional needle of a spray gun system such that the needle is no longer capable of forming a needle-nozzle seal proximate a liquid outlet. In at least one embodiment, the method includes installing a resilient flow control valve within a portion of a liquid passageway of the spray gun system.

In at least one embodiment, a seal is installed in a needle passageway proximate a secondary opening.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a cross-sectioned side view of a prior art spray gun system in accordance with one embodiment.

FIG. 2 illustrates a cross-sectioned side view of a portion of the spray head assembly in FIG. 1 in which selected portions have been removed to illustrate certain features more clearly.

FIG. 3 illustrates a cross-sectioned side view of a prior art spray gun system in accordance with one embodiment.

FIG. 4 illustrates a block diagram of a spray gun system 400 with a resilient flow control valve in accordance with one embodiment.

FIG. 5A illustrates a cross-sectioned view of a resilient flow control valve 510 in a closed configuration in accordance with one embodiment.

FIG. 5B illustrates a cross-sectioned view of a resilient flow control valve 510 in an open configuration in accordance with one embodiment.

FIG. 6 illustrates a flowchart of a method in accordance with one embodiment.

FIG. 7 illustrates a cross-section of a prior art spray gun system with a sealing structure installed in accordance with one embodiment.

FIG. 8 illustrates a cross-sectioned perspective view of a modified spray gun system in accordance with one embodiment.

FIG. 9 illustrates a cross-sectioned perspective view of a modified spray gun system showing a sealing structure in accordance with one embodiment.

FIG. 10 illustrates a cross-sectioned perspective view of a modified spray gun system in accordance with one embodiment.

FIG. 11 illustrates a cross-sectioned perspective view of a modified nozzle assembly in accordance with one embodiment.

FIG. 12A illustrates a perspective view of a nozzle assembly in accordance with one embodiment.

FIG. 12B illustrates a side cross-sectioned view of the nozzle assembly from FIG. 12A in accordance with one embodiment.

FIG. 13 illustrates a cross-sectioned perspective view of a nozzle assembly in accordance with one embodiment.

FIG. 14A illustrates a perspective view of a nozzle assembly in accordance with one embodiment.

FIG. 14B illustrates a cross-sectioned view of the nozzle assembly in FIG. 14A in accordance with one embodiment.

FIG. 15A illustrates a nozzle assembly with a resilient flow control valve in accordance with one embodiment.

FIG. 15B illustrates the resilient flow control valve of FIG. 15A installed in the nozzle assembly in accordance with one embodiment.

FIG. 16 illustrates a modified needle assembly in accordance with one embodiment.

FIG. 17 illustrates a modified needle assembly in accordance with one embodiment.

### DETAILED DESCRIPTION

The spray equipment of the present disclosure can allow a user to create a spray of atomized liquid for use in a variety of coating applications. Such coating applications can be performed to enhance appearance, impart corrosion protection, impart abrasion resistance, increase moisture resistance, and improve cleanability of substrates.

Aspects of the present disclosure relate to spray equipment that are modified to use a resilient flow control valve within a liquid passageway formed therein to control the delivery of a liquid without the use of manually-operated valves such as needle valves actuated by a trigger or actuator. The resilient portion of the resilient flow control valve has the ability to adjust its opening behavior based upon variations in differential pressure, and possesses inherent resiliency to remain in a normally-closed configuration once a pre-determined differential pressure is achieved.

Further aspects of the present disclosure relate to a method of replacing a conventional needle with a resilient flow control valve for use in a spray gun system. The needle passageway of the spray gun system can be sealed and may form a non-wettable needle chamber and a wettable needle chamber. The sealing can be performed based, at least in part, on a position of a pre-existing packing seal.

Resilient portions used in the present disclosure are made preferably from materials which are resilient, elastic, and flexible. Such materials are chosen to impart the ability of the valve to regain its initial shape after being deformed in use (i.e., bending, stretching, compression, etc.). These materials can include but are not limited to natural and synthetic rubbers (EPDM, silicone rubber, etc.), thermoplastic polymers (LDPE, polypropylene, etc.), elastomers, thermosetting polymers, and thermoplastic elastomers (including Thermoplastic Vulcanizates, Thermoplastic polyurethanes, Thermoplastic copolyester, Thermoplastic polyamides, etc.).

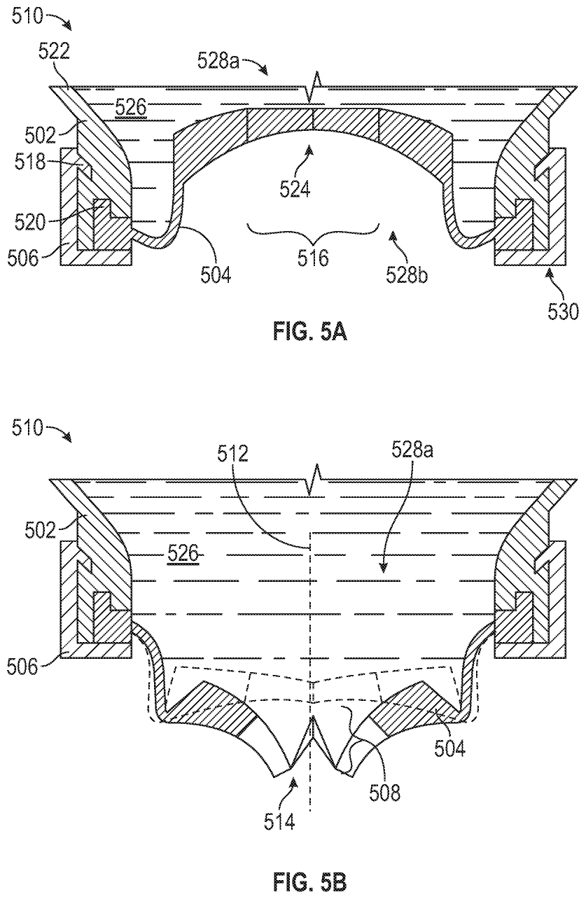

The shape and/or deformation of the resilient portion is affected by the surrounding fluid. As such, it is important to describe how such a process might occur. Resilient portions can be understood to have two “sides” and describe their orientation relative to the fluid flow. The upstream side (e.g., upstream side 528a in FIG. 5A) faces toward a liquid inlet and has a fluid pressure which acts upon it (P1) from the liquid. The downstream side (e.g., downstream side 528b in FIG. 5A) faces the liquid outlet and also has a fluid pressure which acts upon it (P2). These fluid pressures may be independent of any internal or residual stresses designed into the valve itself. It is understood that the valve's shape can be affected by the difference in fluid pressure between its upstream and downstream sides. This gives rise to the concept of differential pressure (ΔP [symbol] P₁−P₂) across the valve. A positive differential pressure indicates that the average upstream fluid pressure is greater than the average downstream fluid pressure. A negative differential pressure indicates that the average upstream fluid pressure is less than the average downstream pressure.

In a first mode, the resilient portion will have the ability to seal/close in a closed configuration such that liquid (if present on the upstream side 528a) does not flow through it. In the first mode, the resilient portion can be configured to remain closed. The resilient portion may inherently be self-sealing, or the seal may be achieved/aided by a prescribed differential pressure.

By adjusting the fluid conditions surrounding the resilient portion, thus changing the differential pressure, the valve may be deformed from its closed configuration (in a first mode of operation of the spray gun system) to an open configuration (e.g., in a second mode of operation of the spray gun system illustrated by FIG. 5B) which allows an opening to overcome the opening pressure and liquid to flow through the valve. The resilient portion can include an attachment structure configured to seal against a component of the resilient flow control valve and/or the nozzle assembly wall.

The spray equipment of the present disclosure may reduce the number of components, complexity, cost, eliminate the need for precision machined needles and seals used in the spray equipment, enable nozzle designs which are more easily removeable from the spray equipment, and enable nozzle designs which keep the paint reservoir sealed from atmosphere even when disconnected from the spray equipment. Such an approach differs in that it does not require a precision machined needle, precision machined valve seat, packing seal, nor needle spring as typically found in spray equipment of the prior art.

Additional aspects of the present disclosure can relate to positioning the resilient flow control valve adjacent to the liquid outlet (e.g., within 5 cm). Such a configuration can further reduce the amount of liquid that is retained by a nozzle assembly and improve cleaning of the nozzle assembly.

Although spray equipment of the present disclosure is designed to address some of the drawbacks associated with current manual, hand-held spray guns, as mentioned above, it should be understood that the concepts disclosed herein could be easily configured for other devices and/or applications that atomize liquid without straying from the scope of the present disclosure.

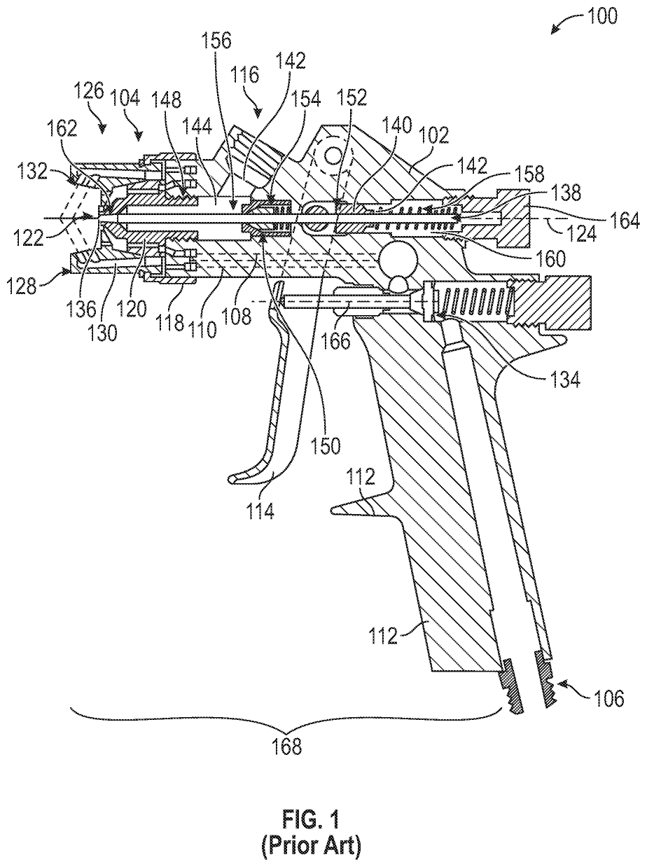

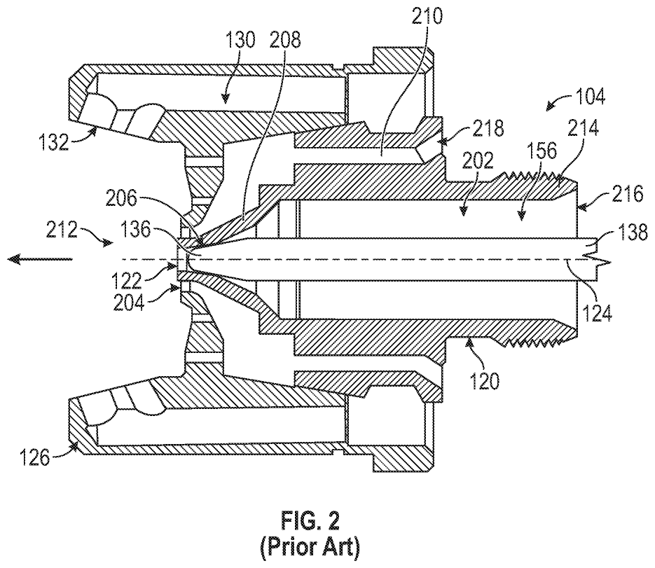

FIG. 1 and FIG. 2 illustrate a spray gun system 100. The spray gun system 100 includes a spray gun platform 102 and a nozzle assembly 104.

The spray gun platform 102 includes a gas inlet 106 that is configured to couple with a gas source (not shown). The spray gun platform 102 can also include a grip portion 112, trigger 114, and liquid inlet 116 for connection to a compatible liquid reservoir system (not shown).

In at least one embodiment, a liquid passageway 144 can be formed within the spray gun platform 102 between the liquid inlet 116 and a liquid outlet 122. The liquid passageway 144 can also include a liquid chamber 146. If the nozzle assembly 104 is removed, then the liquid passageway 144 can be formed between the liquid inlet 116 and an opening adjacent to the attachment structure 148 where the spray gun platform 102 can attach to the nozzle assembly 104.

In at least one embodiment, the liquid passageway 144 (e.g., liquid chamber 146) can share portions with a needle passageway 160 (e.g., portions of wettable needle chamber 156). The needle passageway 160 is configured to hold a conventional needle 138 used in operation of the spray gun system 100. The needle passageway 160 can be configured to allow a conventional needle 138 to axially pass thru the spray gun platform 102 and/or nozzle assembly 104. In at least one embodiment, the needle passageway 160 is formed in portions of the nozzle assembly 104 and the spray gun platform 102. The needle passageway 160 can have a length dimension 168 that is approximately the size of the conventional needle 138.

The needle passageway 160 can include a non-wettable needle chamber 158, and a wettable needle chamber 156 which is separated from a non-wettable needle chamber 158 via a secondary opening 154 and/or packing seal 150. In at least one embodiment, the secondary opening 154 leads into the wettable needle chamber 156 and divides the wettable needle chamber 156 from the non-wettable needle chamber 158.

In at least one embodiment, the wettable needle chamber 156 is a portion of the needle passageway 160 that is configured to contact the liquid. Both the wettable needle chamber 156 and the non-wettable needle chamber 158 can each further include one or more chambers. In at least one embodiment, the needle passageway 160 can be oriented parallel or coaxially with the spray axis 124

In at least one embodiment, a conventional needle 138 has a needle boss 140 that is configured to engage with a trigger-valve engagement interface 152 and a biasing mechanism 142. The biasing mechanism 142 can further abut against an adjustment knob 164. The adjustment knob 164 can restrict movement of the conventional needle 138 in a direction opposite from the needle tip 136 along the spray axis 124. In at least one embodiment, the conventional needle 138 can be disposed axially within the needle passageway 160 such that is capable of translational movement.

In at least one embodiment, a packing seal 150 can be used to slidably seal the conventional needle 138 against the secondary opening 154. The packing seal 150 can divide the wettable needle chamber 156 from the non-wettable needle chamber 158. A fluid-tight seal between the spray gun platform 102 and nozzle liquid passageway 202 can be formed through the packing seal 150. Over time, the packing seal 150 may wear, and as such, can be replaced.

The spray gun platform 102 can have gas passageways (e.g., shaping gas passageway 110, and atomizing gas passageway 108) formed therein and fluidically coupled to the gas inlet 106 at one end. At the opposite end, the gas passageway can releasably couple to gas passageways within the nozzle assembly 104.

In at least one embodiment, the nozzle assembly 104 can be a nozzle cartridge (which is described further herein).

As shown, the nozzle assembly 104 can be coaxial or parallel with the spray axis 124. For example, the nozzle assembly 104 can include a spray gun nozzle body 120 having a nozzle gas inlet 218 and a nozzle gas outlet (e.g., the annular opening 204) which forms an atomizing gas passageway 210 therebetween. The spray gun nozzle body 120 has a nozzle liquid passageway 202 that is aligned along the spray axis 124 and a nozzle liquid inlet 216 that is configured to couple to a liquid outlet (e.g., liquid chamber) on the spray gun platform 102. The secondary opening 154 is located in the spray gun platform 102 as shown. In at least one embodiment, the secondary opening 154 can be collocated with the packing seal 150 and can divide the wettable needle chamber 156 from the non-wettable needle chamber 158.

The atomizing gas passageway 210 is configured to be removably coupled to an atomizing gas passageway 108 of the spray gun platform 102.

The nozzle assembly 104 can include spray gun nozzle body 120, retaining ring 118, air cap 126. Air cap 126 can include an annular opening 204 and two or more diametrically opposed air horns 128 containing horn passageways 130 which terminate at horn outlets 132. Although air horns 128 and air cap 126 are used to describe this configuration, various other gases and/or carrier fluids besides air may also be used.

The spray gun nozzle body 120 can include a liquid outlet 122 that is sealed with a needle tip 136 interacting with a nozzle sealing surface 206 of nozzle wall 208 to form a needle-nozzle seal 162. The spray gun nozzle body 120 can also include a nozzle liquid inlet 216 and a liquid outlet 122 forming the nozzle liquid passageway therebetween. The nozzle liquid passageway 202 can be configured to (1) be removably coupled to a liquid passageway 144 of the spray gun platform 102 at a second end and (2) form a needle-nozzle seal 162 with a conventional needle 138 of the spray gun platform 102 at a first end opposite from the second end.

The spray gun nozzle body 120 can further include an attachment structure 214 (disposed on an outside surface) for attaching to an attachment structure 148 on the spray gun platform 102 and form a releasable connection.

To operate the spray gun system 100, a user's hand depresses the trigger 114 which actuates gas valve 134 via the poppet valve 166 and also causes conventional needle 138 to translate (via needle boss 140 and biasing mechanism 142) along spray axis 124 away from the nozzle sealing surface 206. The actuation of gas valve 134 allows gas to flow from the gas inlet 106, through gas valve 134, and into a shaping gas passageway 110, and an atomizing gas passageway 108.

In operation, gas from the atomizing gas passageway 210 can flow along the exterior of nozzle wall 208 and through annular opening 204 (i.e., forming a gas outlet) creating a venturi effect which pulls liquid from a liquid reservoir system through the liquid inlet 116 and nozzle liquid passageway 202 until the liquid exits the spray gun nozzle body 120 at liquid outlet 122 where the gas atomizes the liquid at mixing zone 212. In some embodiments, the liquid reservoir system can benefit from gravity and/or pressure assistance. For example, the liquid reservoir system can be pressure assisted which can allow handling of viscous liquids.

The mixing zone 212 is where a stream of gas from the atomizing gas passageway 210 exiting the annular opening 204 merges, interacts with, intersects, and/or atomizes a stream of liquid from the nozzle liquid passageway 202 exiting the liquid outlet 122. Gas can exit the horn passageway 130 at horn outlet 132 to shape the atomized liquid creating an approximately elliptical spray pattern.

When the trigger 114 is released, a biasing mechanism (such as a spring) can bias the conventional needle 138 against the nozzle sealing surface 206 to a closed position (thus forming the needle-nozzle seal 162), which shuts off the flow of liquid.

In at least one embodiment, the spray gun system 100 can include a spray gun platform 102 that has both the nozzle liquid passageway 202 and atomizing gas passageway 210 formed therein. Thus, to clean the spray gun system 100, the air cap 126 and the spray gun nozzle body 120 are removed.

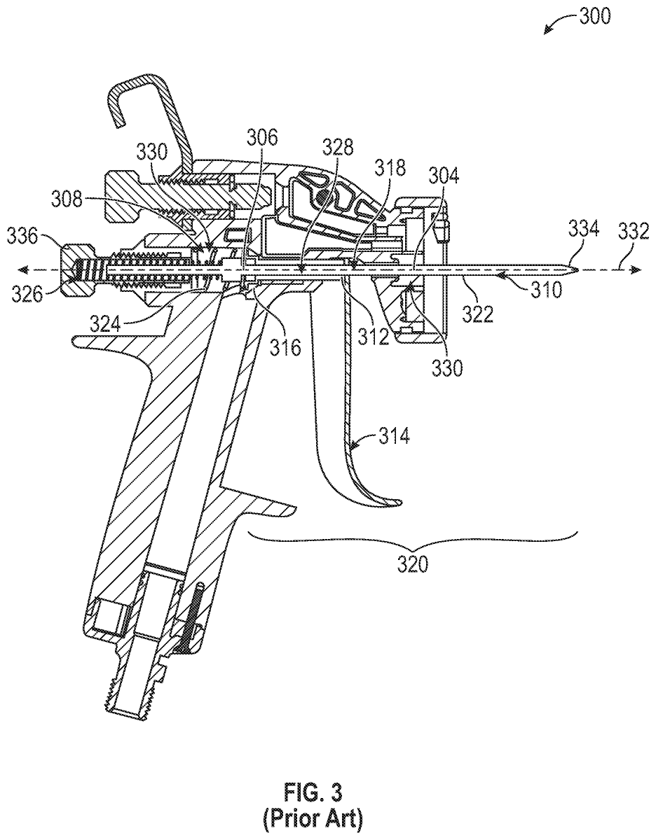

FIG. 3 illustrates a spray gun platform 300 similar to spray gun platform 102 except that the spray gun platform 300 can uses a poppet valve 302 which is coaxial with the conventional needle 310 (FIG. 1 illustrates a stacked configuration between poppet valve 166 and conventional needle 138). In at least one embodiment, the poppet valve 302 can regulate the gas flow while the conventional needle 310 can regulate the liquid flow.

The non-wettable needle chambers 330 can include needle chamber 304 (forward) and needle chamber 308 (rear). The needle chamber 308 can be separated from needle chamber 304 via an air gap.

The conventional needle 310 can include a shaft section 322 and a needle boss 306 configured to engage with both the poppet valve 302 (i.e., at the poppet flange end 316) and the needle biasing mechanism 326. The conventional needle 310 can also include a needle tip 334 configured to engage with a nozzle sealing surface on a corresponding nozzle assembly (not shown). The shaft section 322 can have a dimension 320.

The poppet valve 302 can include a poppet flange end 316 and a poppet distal end 312. A thru passageway 328 can be formed from the poppet flange end 316 to the poppet distal end 312 within a body of the poppet valve 302. The conventional needle 310 can pass thru the thru passageway 328 such that the poppet valve 302 surrounds the conventional needle 310.

In at least one embodiment, the poppet flange end 316 is configured to engage a needle boss 306 and poppet biasing mechanism 324. The adjustment knob 336 is configured to provide a backstop to the needle biasing mechanism 326 and optionally the poppet biasing mechanism 324 such that both the conventional needle 310 and the poppet valve 302 are biased towards the needle tip 334. A trigger 314 can engage with the poppet distal end 312 at the trigger engagement region 318 such that gas is discharged when the trigger 314 is activated and the trigger 314 is configured to translate the conventional needle 310 along the spray axis 332 in response to activation.

When combined with a compatible nozzle assembly (not shown), the needle tip 334 can form a needle-nozzle seal with the nozzle wall in a first mode with no liquid being expelled (when present in the liquid passageway), and the needle-nozzle seal can be broken in response to a second mode, with the poppet valve 302 being opened. In at least one embodiment, the nozzle assembly can couple with a liquid reservoir system and the liquid passageway is not routed through the spray gun platform 300 in a nozzle cartridge configuration. In at least one embodiment, the nozzle assembly can be configured similar to nozzle assembly 104, where the liquid passageway is formed within the spray gun platform 300.

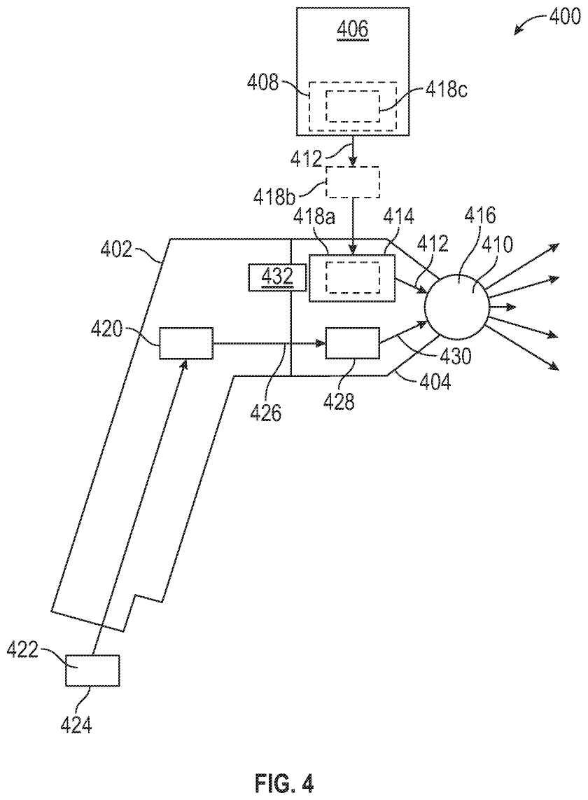

FIG. 4 illustrates a functional block diagram of an assembled spray gun system 400 according to an aspect of the present disclosure. The spray gun system 400 can include a spray gun platform 402, a nozzle assembly 404, a liquid reservoir system 406 having a liquid reservoir outlet 408 and containing a liquid, and a gas source 424 having a gas 422. The liquid reservoir system 406 can include any suitable container, reservoir or housing that can be directly or indirectly (e.g., via a conduit, hose, aerosol can, etc.) attached to the liquid inlet 414 of the nozzle assembly 404. In at least one embodiment, the liquid inlet 414 refers to a functional inlet that is mateable with the liquid reservoir outlet 408 and can be located inside of a body of the nozzle assembly 404. In at least one embodiment, the spray gun platform 402, nozzle assembly 404 and liquid reservoir system 406 (including liquid reservoir components thereof) can be referred to as spray gun components that are configured to attach to the spray gun platform 402.

The liquid reservoir system 406 containing liquid reservoir outlet 408 may be reusable or disposable and can come prefilled with a liquid or be fillable on site. The liquid reservoir system 406 may optionally have a removeable lid portion to aid in the opening and closing of the container. In at least one embodiment, the liquid reservoir system 406 can include a liquid reservoir component such as a gravity-fed liquid reservoir system including a lid, adaptor, or portions thereof. In at least one embodiment, the liquid reservoir outlet 408 can flow into a liquid inlet 414 and out of the liquid outlet 416 in the spray gun system 400. The liquid inlet 414 and liquid outlet 416 can be formed from openings in various components of the spray gun system 400. The liquid inlet 414 and liquid outlet 416 can be connected via the liquid passageway 412.

The gas source 424 may be fluidly isolated from the atmosphere (i.e., closed vessel), or contain a fluid inlet to allow the intake of gas 422 from the surroundings (i.e., air compressor). In at least one embodiment, gas 422 from the gas source 424 can flow into nozzle gas inlet 426 and out of the spray gun system 400 via the gas outlet 430. The nozzle gas inlet 426 and gas outlet 430 can be connected via the gas passageway 428.

In some embodiments, at least one of the gas sources 424 and liquid reservoir system 406 is pressurized. In some embodiments, the gas source 424 is pressurized. In some embodiments, the liquid reservoir system 406 is not pressurized. In other embodiments, the liquid reservoir system 406 is not pressurized by means other than hydrostatic pressure (e.g., the liquid reservoir system 406 is positioned vertically above the nozzle assembly 404 in a gravity-fed configuration).

In at least one embodiment, the spray gun system 400 can have a liquid reservoir system 406 which is fluidly connected to a resilient flow control valve 418a. As depicted in FIG. 4, the resilient flow control valve may be positioned at a variety of locations (e.g., 418a, 418b, 418c all refer to potential locations of the resilient flow control valve) along the liquid flow path from the liquid reservoir system 406 to the mixing zone 410. The term resilient flow control valve 418a can be used interchangeably with resilient flow control valve 418b and resilient flow control valve 418c.

In at least one embodiment, the resilient flow control valve 418a can be placed such that an adequate pressure differential (e.g., sufficient to change the resilient flow control valve 418a to an open configuration) can be created and controlled at that location during operation of the spray gun system 400. In at least one embodiment, a resilient flow control valve 418a is located within the liquid passageway 412 of the nozzle assembly 404. The location of the resilient flow control valve 418a within the liquid passageway 412 can be dependent upon several factors including the size and shape of both the valve and passage, the desirability to have expansion chambers within the liquid passageway, and any considerations around residual liquid present within the liquid passage upon closing of the resilient flow control valve 418a. In at least one embodiment, the resilient flow control valve 418a could be placed in the middle of the liquid passageway 412. In at least one embodiment, the resilient flow control valve 418a is located at the liquid outlet of the liquid passageway 412 such that the outlet of the resilient flow control valve 418a is adjacent the mixing zone 410.

In another embodiment, a resilient flow control valve 418c is located within the liquid reservoir system 406, for example, in a liquid reservoir outlet 408 or lid of a liquid reservoir system 406. In at least one embodiment, the resilient flow control valve 418b can be located within a conduit connecting the liquid reservoir system 406 to the nozzle assembly 404. From the examples given, it should be understood that multiple locations are acceptable for the placement of the resilient flow control valve.

In at least one embodiment, two or more resilient flow control valves may be used within the same spray gun system 400. The use of more than one resilient flow control valve may provide a back-up in the event that another resilient flow control valve fails. Additionally, the use of two or more resilient flow control valve may allow separable components to remain sealed to air when disconnected. In at least one embodiment, resilient flow control valve 418a is located at a liquid inlet 414 to nozzle assembly 404 while another resilient flow control valve 418c is located within a lid of a liquid reservoir system. In at least one embodiment, the liquid inlet 414 can include a portion of a needle passageway which can be sealed by sealing structure 432. When the liquid reservoir system is disconnected from the nozzle assembly, both components can remain sealed to the atmosphere.

The spray gun system 400 may include a gas valve 420 placed between the gas source 424 and the nozzle gas passageway 428 to manage the flow of gas within the spray gun system 400. Exemplary gas valves 420 include poppet, ball, pinch, diaphragm, and needle-style valves commonly used in pneumatic applications. In at least one embodiment, the gas valve 420 can be placed within the spray gun system 400 such that it (indirectly) affects a degree of openness of at least one resilient flow control valve 418a. An indirect fluid communication path may extend across dissimilar passages (i.e., nozzle gas passageway 428 to mixing zone 410 to liquid passageway 412, across dissimilar fluids (i.e., pressure transmitted between gas and liquid), or also across a (deformable) partition separating passages.

The operation of the spray gun system 400 of the present application can be described through a sequence of events. In a first mode, the spray gun system 400 can contain a liquid within the liquid reservoir system 406, and a gas within the gas source 424. In this first mode, both the gas valve 420 and the resilient flow control valve 418a are in a closed position. Due to both valves being closed, there is not flow of either gas or liquid through the spray gun system 400.

In a first mode, the gas valve 420 can be opened which causes gas to flow from the gas source 424 through the gas valve 420. Via the previously described fluid coupling mechanism, the flow of gas in the system alters the differential pressure across the resilient flow control valve 418a. In a first mode, even though gas is flowing, the differential pressure may not be enough to change the resilient flow control valve 418a from the closed configuration. In a second mode, under certain gas flow conditions, a pre-defined opening differential pressure of the resilient flow control valve 418a may be reached, thus causing the resilient flow control valve 418a to change to an open configuration, enabling liquid to pass through the liquid passageway 412 (if the optional liquid is present). With both gas and liquid passing through their respective passages, the two fluids are routed to the mixing zone 410.

Within the mixing zone 410, the atomization and spray formation processes can take place in the second state. The atomization and spray formation processes can result in the creation of a spray including a mixture of at least the two fluids (gas 422 and liquid) wherein the liquid has been atomized into small droplets from its initial bulk fluid state.

When it is desired to reduce or stop the spray emanating from the spray gun system 400, the gas valve 420 may be either partially or fully closed. By closing the gas valve 420 (e.g., by a user interacting with an actuator), the flow of gas through the spray gun system 400 can be stopped, and in turn, the differential pressure across the resilient flow control valve 418a can be reduced. When the prescribed closing differential pressure of the resilient flow control valve 418a is reached, the resilient flow control valve 418a can seal itself and stop the flow of liquid through the liquid passageway 412. This closing process returns the spray gun system 400 to the first mode.

FIG. 5A and FIG. 5B illustrate a cross-sectional view of the resilient flow control valve 510. FIG. 5A illustrates the resilient flow control valve 510 in a first mode, and FIG. 5B illustrates the resilient flow control valve 510 in a second mode.

The resilient flow control valve 510 is known in the art and referred to in many ways including resilient valves, resilient closure members, discharge valve members, deformable outlet valves, dispensing closures, valve-controlled dispensing closures, elastomeric valves, cross-slit valves, and duckbill valves (not all encompassing). Examples of such valves can include but are not limited to EP3,280,652 B1, U.S. Pat. Nos. 1,739,871, 5,676,289, and 6,053,194. Applications of such valves include food and beverage containers, powder, lotion, and soap dispensers, and hand-pump spray bottles to name a few.

In at least one embodiment, the resilient flow control valve 510 comprises at least a resilient portion 504 and optionally a frame structure 506 and/or a support portion 502. The components of the resilient flow control valve 510 can be formed from separate and distinct materials, each with their own properties.

The frame structure 506 can have a structure that is configured to mate with the retention structure of the nozzle assembly. The frame structure 506 can be relatively more rigid than the resilient portion 504 (e.g., as measured using a shore A hardness test method). For example, the frame structure 506 can be rigid, while the resilient portion 504 is elastomeric. The frame structure 506 can be configured to bond with both the resilient portion 504 and the support portion 502. The frame structure 506 can include various attachment features to facilitate mechanical engagement with the nozzle assembly or other components of the resilient flow control valve 510. For example, the frame structure 506 can include a barb 518 to secure the resilient portion 504 via the support portion 502. The frame structure 506 can have a sealing surface 530 that is configured to form a fluid-tight seal with a complementary sealing surface within the liquid passageway.

In at least one embodiment, the frame structure 506 can be annular such that each portion of the frame structure 506 is equidistant from the center of the opening 514. By having a frame structure 506, an edge of the resilient portion 504 can be anchored within the liquid passageway and the position of the resilient portion 504 can be maintained throughout any differential pressure. Further, by having the frame structure 506 separate from the resilient portion 504, the nozzle assembly can be customizable depending on the application by replacing the resilient flow control valves 510.

In at least one embodiment, the support portion 502 can be a component that acts as an intermediary between the resilient portion 504 and the frame structure 506. As shown in FIG. 5A, the support portion 502 is also configured to direct a liquid toward the resilient portion 504.

In at least one embodiment, the support portion 502 can be formed from a more rigid material than the resilient portion 504. In at least one embodiment, the support portion 502 can be configured to promote bonding of the resilient portion 504 to the frame structure 506 and/or dissipate force from the resilient portion 504. The support portion 502 can have features that aid in the retention and/or force dissipation of the resilient portion 504 with respect to the frame structure 506. For example, the support portion 502 can include a complementary feature configured to mate with barb 518 on the frame structure and another complementary feature configured to mate with attachment structure 520 on the resilient portion 504. In at least one embodiment, the support portion 502 or the frame structure 506 can have a rim 522 on the distal surface opposite from the opening 514 direction. In at least one embodiment, the rim 522 can have an outer radial diameter (e.g., measured in a plane orthogonal to the resilient flow control valve axis 512) that is greater than the outer radial diameter of the frame structure 506.

Resilient portions may be designed with a pre-defined opening differential pressure (e.g., opening pressure) which signifies when the valve deformation transitions from the first mode to the second mode. The degree of openness, or variation in the resilient portion's open cross-sectional area, may be further controlled by the magnitude of the differential pressure. This provides for a degree of flow regulation in that there are many possible deformable states of the resilient flow control valve between a closed configuration and an open configuration. Another important feature of the resilient portion is that it may be returned to the first mode upon removal of the differential pressure stimulus. A closing differential pressure may be designed into or characteristic of the valve which describes when the valve will transition from a second mode back to a first mode. In at least one embodiment, aspects of the resilient portion can dispense liquid in response to a differential pressure across the resilient portion 504.

The resilient portion 504 can have a self-sealing opening 514 formed from one or more slits 524 therein. When in a closed configuration, the one or more slits 524 can be touching each other and forming a fluid-tight seal. The one or more slits 524 can be a feature that permits an opening 514 to form in the resilient portion 504 when the resilient portion 504 is in the open configuration and in response to an opening pressure. In at least one embodiment, the one or more slits 524 can be horizontal, vertical, a combination, or even cross and star patterns. The one or more slits 524 can have a first slit dimension 516 which can be designed such that the intended liquid 526 will dispense from opening 514 when a target pressure differential is achieved from upstream side 528a to downstream side 528b. The first slit dimension 516 can further control the flow rate of the liquid 526.

As shown on FIG. 5B, when in the open configuration, the opening 514 can open outwardly along a resilient flow control valve axis 512 (towards the direction of liquid 526 flow). The liquid flow rate of the resilient portion 504 can be controlled based on the open area formed by the one or more slits 524. The open area can be partly defined by second slit dimension 508 and first slit dimension 516. In at least one embodiment, the second slit dimension 508 is defined along the resilient flow control valve axis 512 and the second slit dimension 508 is defined in a plane orthogonal to the resilient flow control valve axis 512.

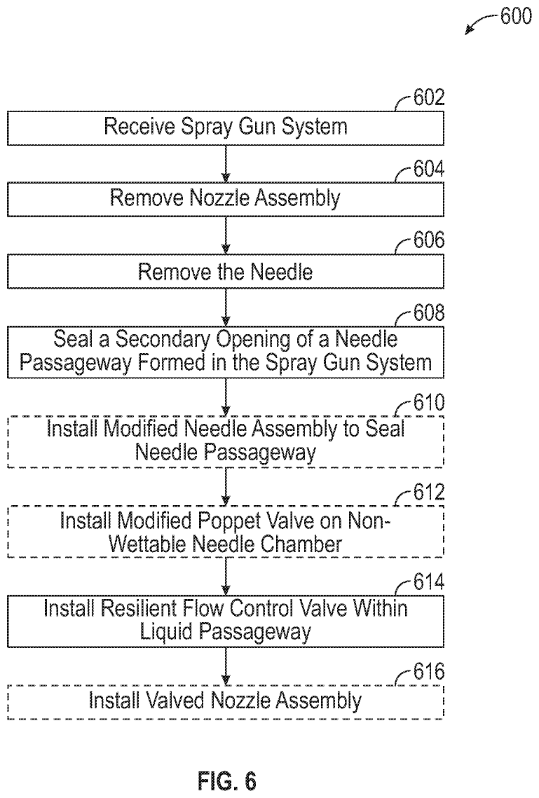

FIG. 6 illustrates a flowchart of a method 600 of modifying a spray gun system to include a resilient flow control valve. Aspects of method 600 can be discussed with reference to the figures herein. The method 600 can start in block 602.

In block 602, a user can receive the spray gun system to be modified. In at least one embodiment, the spray gun system can include a spray gun platform such as those described in FIG. 1, FIG. 2, and FIG. 3. The spray gun system can include a spray gun platform that includes the liquid inlet, the secondary opening, and the liquid outlet forming a liquid passageway therebetween.

In block 604, the user can remove the nozzle assembly from the spray gun platform prior to sealing the secondary opening. For example, the attachment structure on the nozzle assembly can be threaded on like shown in FIG. 1, or can be retained by a retaining ring, protrusions, clips, channels, or combinations thereof.

In block 606, the user can remove a conventional needle from the needle passageway of the spray gun platform and/or the nozzle assembly. For example, an adjustment knob could be removed to remove the biasing mechanism (such as those for the poppet valve or the conventional needle).

In at least one embodiment, block 606 can be optional. For example, if the resilient flow control valve were installed adjacent to the liquid passageway (e.g., on a lid, hose, or over the liquid outlet), then the needle does not need to be removed. Thus, the benefits of having a resilient flow control valve in the lid can be obtained without needing to supply the parts to change over the spray gun system to not use a conventional needle.

In block 608, the user or third-party can seal a secondary opening of a needle passageway formed in a spray gun system comprising a spray gun platform and a nozzle assembly. For example, the user can seal the needle passageway by installing a sealing structure which can fluidically separate the wettable needle chamber from the non-wettable needle chamber.

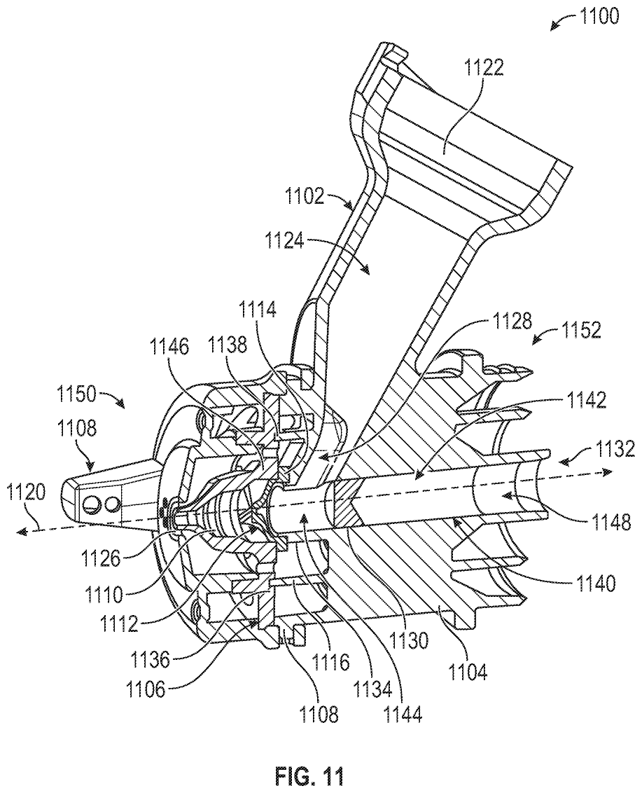

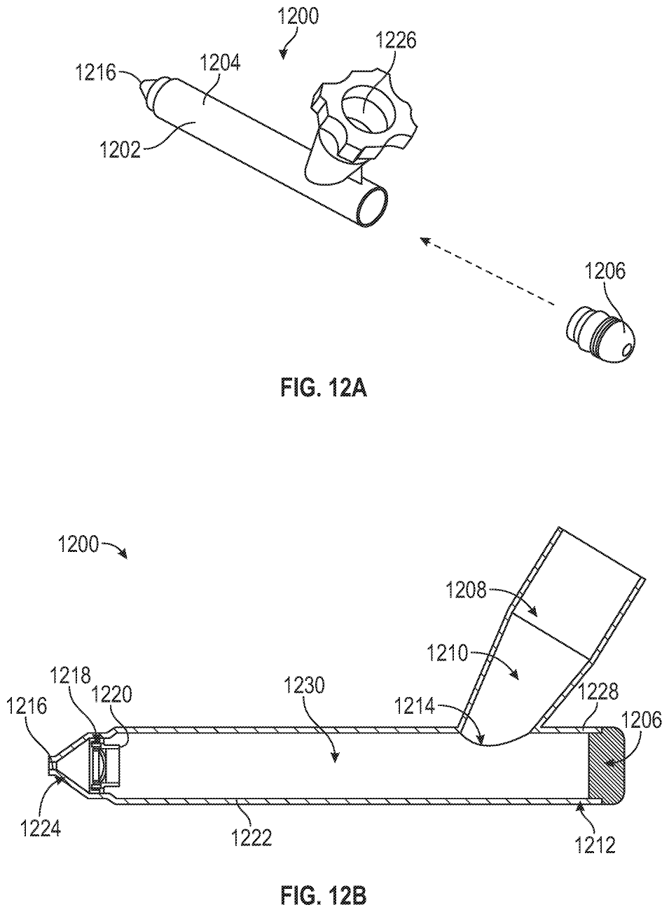

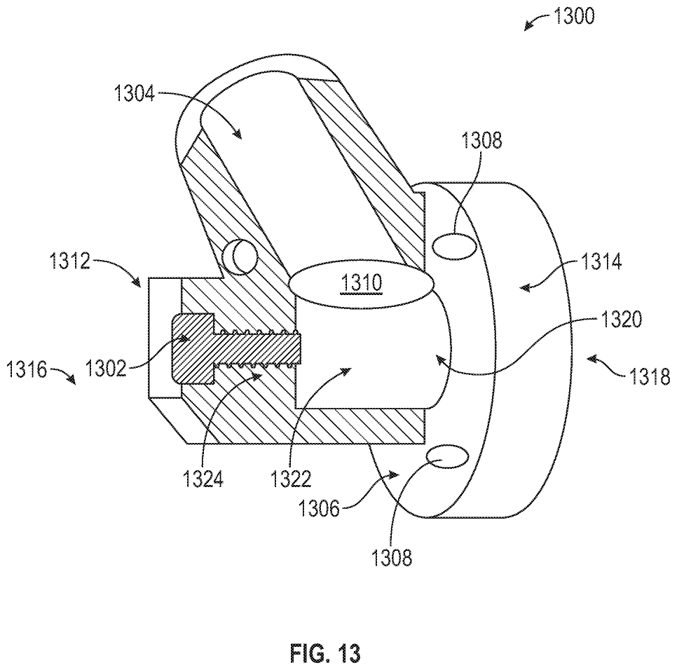

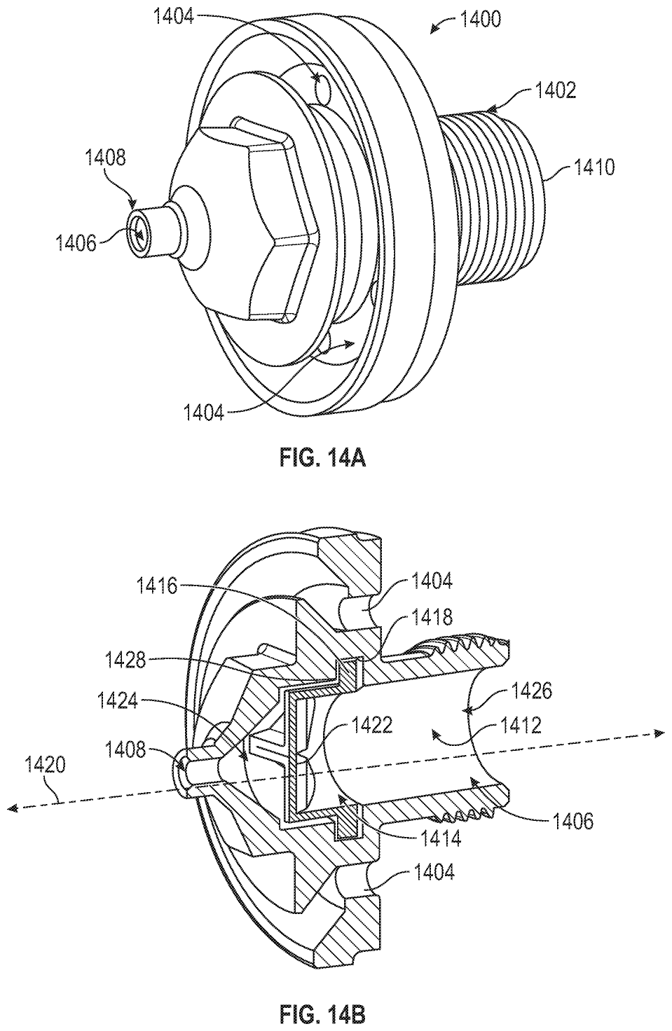

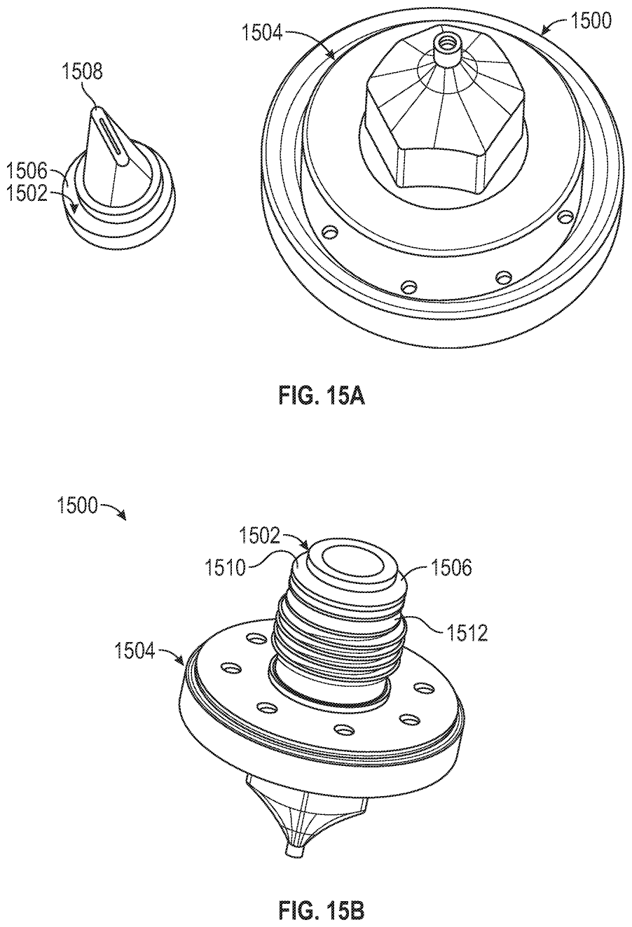

Examples of replacement or modified nozzle assemblies are described in greater detail herein. For example, FIG. 11, FIG. 12A, FIG. 12B, and FIG. 13 illustrate a nozzle assembly that is a nozzle cartridge that can be removably coupled to the spray gun platform such as that of FIG. 3. In another example, FIG. 14A, FIG. 14B, FIG. 15A, FIG. 15B illustrate a nozzle assembly having a nozzle assembly body that can be removably coupled to the spray gun platform such as that of FIG. 1.

In at least one embodiment, the sealing can be performed separate from the user. For example, a third-party can provide a modified needle assembly for use with a spray gun system. Embodiments of block 608 can be described more specifically herein.

In at least one embodiment, block 608 does not include using a conventional needle to perform the sealing. For example, the secondary opening of the needle passageway can be sealed using an existing packing seal already present in the spray gun platform or nozzle assembly and a user can remove the conventional needle in block 606 and install a modified needle assembly in block 610.

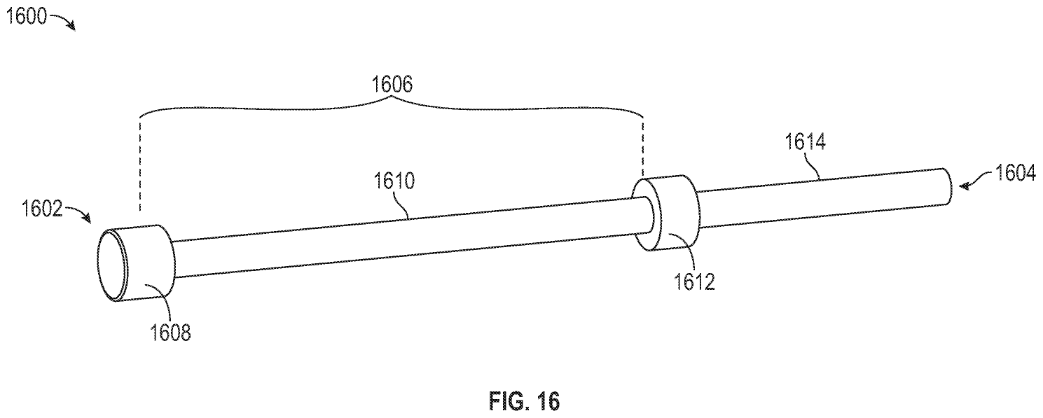

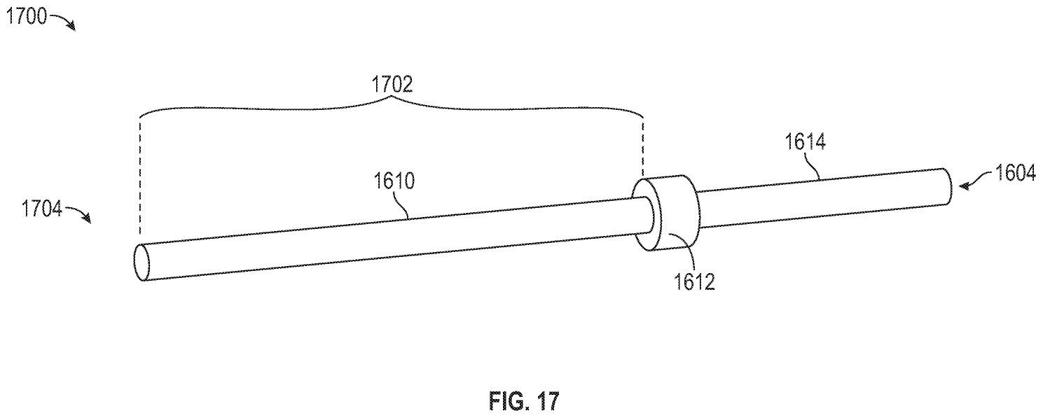

Turning to examples, FIG. 16 and FIG. 17 illustrate examples of modified needle assemblies useful in the present disclosure and are described further herein. The modified needle assembly can be configured such that it does not form a needle-nozzle seal with the spray gun system. For example, a length dimension of the modified needle assembly can be less than a compatible conventional needle so that the needle-nozzle seal is not formed but a shaft of the modified needle assembly can be slidable with and form a seal with the packing seal. In at least one embodiment, a first end of modified needle assembly is at least 0.5 mm, or, in some embodiments, a dimension of the resilient flow control valve, from the resilient flow control valve when installed. In at least one embodiment, installing the modified needle assembly can further comprise modifying a conventional needle of a spray gun system such that the needle is no longer capable of forming a needle-nozzle seal proximate a liquid outlet. For example, a user could cut off a portion of the needle to allow sealing with an existing packing seal and avoid forming a needle-nozzle seal when the spray gun system is in a first mode.

In block 612, a user can optionally install a modified poppet valve into a non-wettable needle chamber. For example, the modified poppet valve can be configured to (1) not allow a needle to pass thru, (2) slidably seal the non-wettable needle chamber, and (3) engage with a trigger of the spray gun platform. The modified poppet valve can be configured without a through hole and configured to not work with a needle. Thus, block 612 and block 610 can be mutually exclusive in some embodiments.

In block 614, the user or third-party can install a resilient flow control valve within a portion of a liquid passageway formed in the spray gun system. The installation of the resilient flow control valve can occur such that liquid is capable of being contained by the resilient flow control valve without leakage through a liquid outlet, the nozzle liquid outlet, a slit, and/or secondary opening. In at least one embodiment, the leakage can be determined when the spray gun system is at rest (meaning no gas is flowing through the spray gun system), and/or in a first mode. In at least one embodiment, the resilient flow control valve can form a fluid-tight seal within the liquid passageway (i.e., with a sealing surface of the resilient flow control valve) to be sealingly engaged. The liquid passageway and needle passageway are fluidically coupled.

In block 616, a user can install the valved nozzle assembly onto the spray gun platform. The nozzle assembly can include a nozzle assembly body or a nozzle cartridge. The valved nozzle assembly can fit and/or connect similarly to the original nozzle assembly for the spray gun system.

Once the resilient flow control valve is installed in block 616 and when the nozzle assembly is assembled with the spray gun platform and operating in a first mode, a differential pressure across the resilient flow control valve is less than an opening pressure of the resilient flow control valve and results in a closed configuration. In a second mode, gas flow from a spray gun system including the spray gun platform and a nozzle assembly causes the differential pressure across the resilient flow control valve to be at least the opening pressure of the resilient flow control valve and thereby causes the resilient flow control valve to change to an open configuration.

In at least one embodiment, the method 600 can further include attaching pressurized air to a gas inlet of the spray gun system (once assembled). The liquid through a liquid outlet can cease through operation of the resilient flow control valve in response to the pressurized air, and not a needle valve.

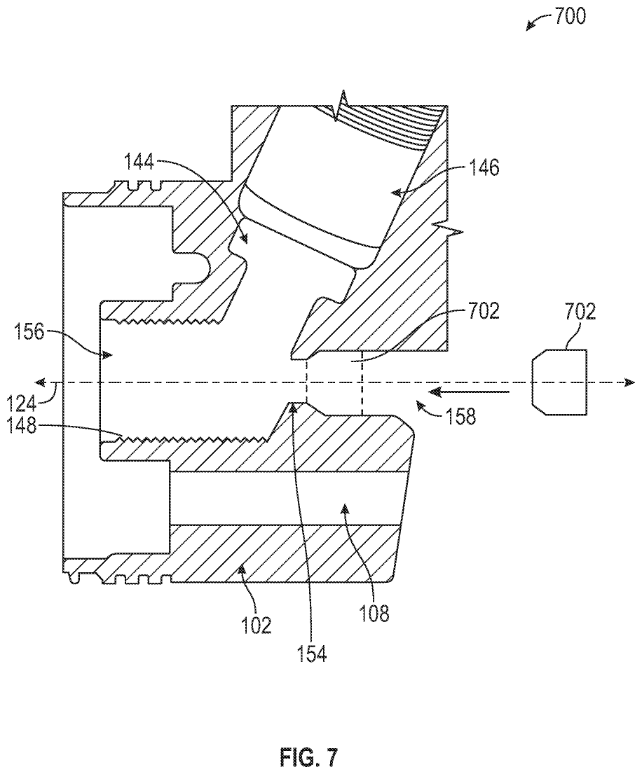

With respect to block 608, in FIG. 7, a close up of the spray gun platform 102 from FIG. 1 is shown. After the conventional needle is removed, then a sealing structure 702 can be used to seal the non-wettable needle chamber 158 from the wettable needle chamber 156 or form a wettable needle chamber 156 from the needle passageway 160. For example, the sealing structure 702 can be pushed in axially along the needle/spray axis 124 via the non-wettable needle chamber 158 and can plug/seal the secondary opening 154 in a fluid-tight manner.

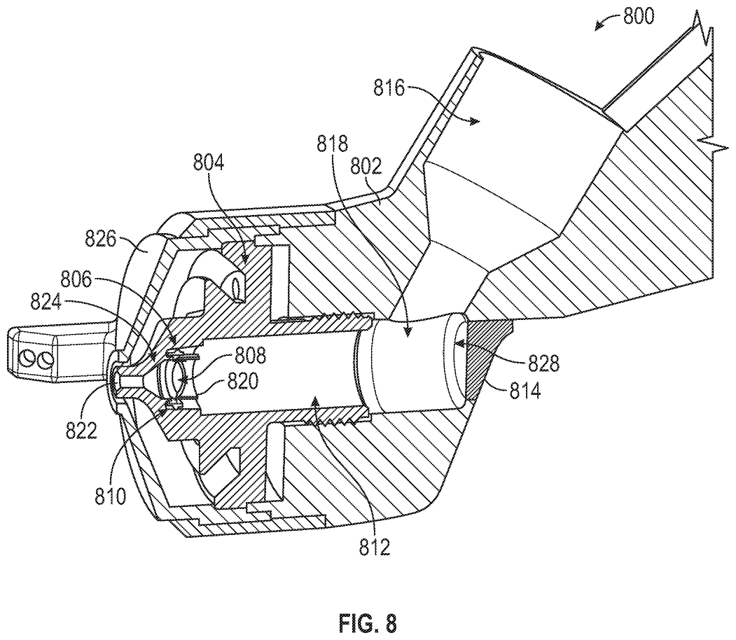

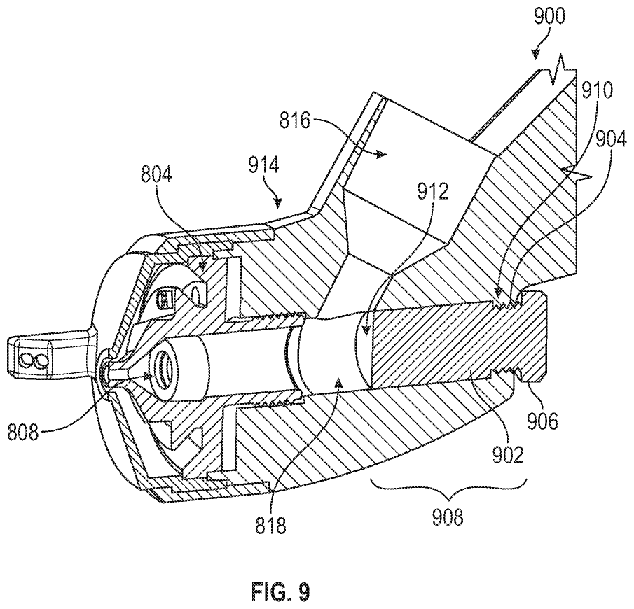

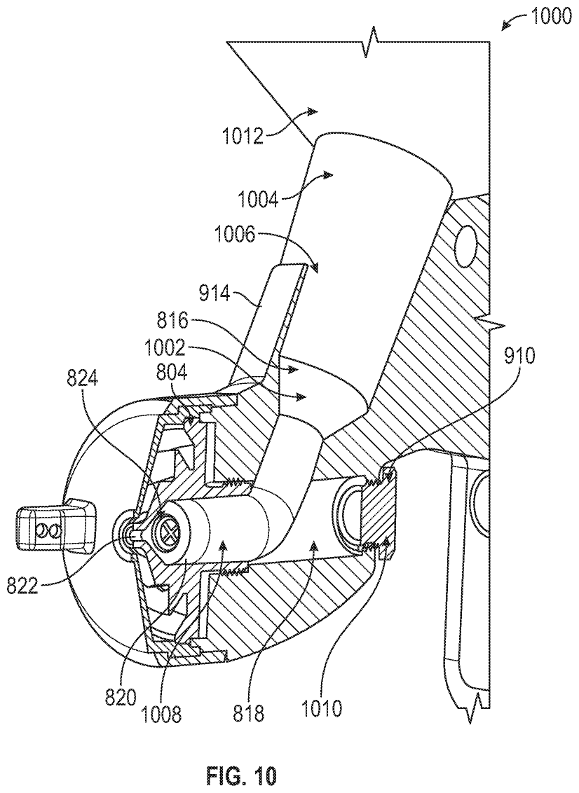

FIG. 8, FIG. 9, and FIG. 10 illustrate an embodiment that may utilize a poppet valve (not shown) similar to in FIG. 3.

In FIG. 8, a spray gun system 800 in an assembled state having the spray gun platform 802, the nozzle assembly 804, and an air cap 826.

The spray gun platform 802 is shown with a liquid passageway 816 and wettable needle chamber 818 formed therein. In at least one embodiment, a portion of the liquid passageway 816 (but not the entirety of the liquid passageway 816) is coaxial with the wettable needle chamber 818. For example, the portion of the liquid passageway 816 not coaxial with the wettable needle chamber 818 can direct liquid into the wettable needle chamber 818.

The liquid passageway 816 can lead into the liquid outlet 822 in the nozzle assembly 804. In at least one embodiment, the secondary opening 828 can lead into the wettable needle chamber 818. In place of a packing seal at the secondary opening 828, a wall 814 can be formed over the secondary opening 828. Thus, the wettable needle chamber 818 can be completely sealed off in block 608. In at least one embodiment, the wall 814 can be angled (non-perpendicular) relative to the wettable needle chamber 818 to facilitate the flow of liquid from the liquid passageway 816.

In block 614 from FIG. 6, a user can install a resilient flow control valve 808 in the nozzle liquid passageway 812. For example, the resilient flow control valve 808 can be installed against a nozzle sealing surface 824. In at least one embodiment, an attachment structure 810 can be formed on the nozzle sealing surface 824 to retain and form a fluid-tight seal with the resilient flow control valve 808. For example, the attachment structure 810 can be a groove molded into the nozzle liquid passageway 812. The groove is shown as an annular groove adjacent to a nozzle sealing surface 824 of the nozzle assembly 804.

The resilient flow control valve 808 can have a frame structure 820 to provide structure to the resilient portion (described in FIG. 5A and FIG. 5B) and enables the attachment structure 810 to mate with a complementary attachment structure 806 on the nozzle assembly 804. The frame structure 820 can have a complementary attachment structure 806 to mate with the attachment structure 810. The nozzle assembly 804 can expel the liquid through the liquid outlet 822 when the differential pressure across the resilient flow control valve 808 exceeds an opening pressure. This could be done, for example, by applying negative pressure around the liquid outlet 822 (e.g., by causing gas to flow around the liquid outlet 822).

In FIG. 9, the spray gun system 900 can be similar to the spray gun system 800 except that, in block 608, the sealing structure 902 is inserted through the secondary opening 910 leading to the wettable needle chamber 818. This sealing structure 902 may be compressible upon insertion into the secondary opening 910, and expand to form a liquid-tight seal when in place.

The sealing structure 902 can also have a stepped portion 904 that is configured to be sized according to a radial dimension of the secondary opening 910 of the spray gun platform. In at least one embodiment, the sealing structure 902 can be a plug that has a stepped portion 904 and a retention structure 906 configured so that the sealing structure 902 is restricted from extending past the dimension 908. The sealing structure 902 can have a distal end 912 that abuts the liquid passageway 816. In at least one embodiment, a user can insert the sealing structure 902 into the secondary opening 828 and at least partially into the wettable needle chamber 818. The sealing structure 902 can be configured to attach to a body of the spray gun platform 914 (or the nozzle cartridge) and fill in the secondary opening 910.

The wettable needle chamber 818 can have a dimension 908 that branches from the liquid passageway 816. In at least one embodiment, the sealing structure 902 can be configured to fill in a majority of the dimension 908.

FIG. 10 illustrates a spray gun system 1000 that is similar to spray gun system 900 except that the sealing structure 902 is optional and functions as a dust cover and the second fluid passageway includes a liner tube 1002 that fluidically isolates the liquid from the wettable needle chamber 818.

The spray gun system 1000 can include the spray gun platform 914 and nozzle assembly 804 as described in FIG. 9. The spray gun system 1000 can also include a liner assembly 1004 that can function as a fluid pathway that delivers liquid from the liner liquid inlet 1012 through the resilient flow control valve 808, and out through the liquid outlet 822. In block 608, the secondary opening 910 can be sealed by inserting a sealing structure 1010 which can be shorter than the sealing structure 902. For example, the sealing structure 1010 does not fill out a majority of the wettable needle chamber 818.

The liner assembly 1004 can include a liner liquid inlet 1012 (which may receive liquid from a liquid reservoir system) at one end, and a distal end 1008 (which may be coupled to a resilient flow control valve 808) at the opposite end. The liner assembly 1004 can have a liner tube 1002 connecting the liner liquid inlet 1012 to the distal end 1008 such that any liquid from the liner liquid inlet 1012 is transported through and can be contained by the liner tube 1002. The liner tube 1002 can be flexible to enable the distal end 1008 to snake through the liquid passageway 816 and into the nozzle assembly 804. The liner tube 1002 can also have a length dimension sufficient to allow the distal end 1008 or the resilient flow control valve 808 abut the nozzle sealing surface 824 of the nozzle assembly 804.

In at least one embodiment, the liner tube 1002 is self-contained and fluidically coupled to a liquid reservoir system. In at least one embodiment, the liner tube and liquid reservoir system can be integral and can contain a liquid that is pre-filled which would result in the liquid being completely contained in a closed system.

In at least one embodiment, sealing the secondary opening 910 can further include inserting a liner assembly 1004 into a liquid inlet 1006, through a portion of a liquid passageway 816, and toward a liquid outlet 822. The insertion can be performed by the user installing (e.g., by snaking) a distal end 1008 of the liner assembly 1004 through the liquid passageway 816. In at least one embodiment, the liner tube 1002 is configured to pass through and conform to portions of (1) the liquid passageway 816 of the spray gun platform 802 and/or (2) the nozzle liquid passageway 812 of the nozzle assembly 804.

In at least one embodiment, the distal end 1008 of the liner tube 1002 has the resilient flow control valve 808 installed thereon. In at least one embodiment, the frame structure 820 can be integrally formed with the distal end 1008.

In at least one embodiment, the resilient flow control valve 808 or the distal end 1008 can have sealing features that facilitate the resilient flow control valve 808 maintaining a fluid-tight seal against the distal end 1008. Examples of sealing features include diametric interference (press fit), clamping members, adhesives, magnetic members, or elastomeric members such as o-rings. Thus, the liquid from liner liquid inlet 1012 can only exit the spray gun system 1000 at the resilient flow control valve 808. In at least one embodiment, the liner assembly 1004 is configured to contain liquid from the liner liquid inlet 1012 through a distal end 1008 of the liner tube 1002.

FIG. 11 illustrates a valved nozzle assembly 1100 that is in a nozzle cartridge. The valved nozzle assembly 1100 can be modified from nozzle cartridges commercially available for the Performance Spray Gun from 3M (Saint Paul, MN). For example, the valved nozzle assembly 1100 can include an air cap 1108 and a nozzle assembly body 1102. In at least one embodiment, the block 608 and block 614 of the method 600 can be performed at a third-party facility such that the resulting valved nozzle assembly 1100 is readily installed by the user in block 616.

The nozzle assembly body 1102 can optionally be formed from multiple portions including a barrel body 1104, and a liquid nozzle portion 1106. A resilient flow control valve 1112 can be sandwiched between the barrel body 1104 and the liquid nozzle portion 1106 in valved nozzle assembly 1100.

The nozzle assembly body 1102 can have a first end 1150 and a second end 1152. The second end 1152 is configured to attach to a compatible spray gun platform as depicted on FIG. 3. For example, the non-wettable needle chamber 1142 can be coupled to needle chamber 304 and the nozzle gas passageways in the valved nozzle assembly 1100 can be coupled to the gas passageways in the spray gun platform 300 in FIG. 3.

The nozzle assembly body 1102 can include a liquid inlet 1122 and a liquid outlet 1126. A nozzle liquid passageway 1124 is formed between the liquid inlet 1122 and liquid outlet 1126. The nozzle assembly body 1102 can include a needle passageway 1140 formed therein. The needle passageway 1140 may have originally been designed to receive a packing seal that divided the needle passageway 1140 into a wettable needle chamber 1144 and a non-wettable needle chamber 1142. The needle passageway 1140 can be coaxial with the spray axis 1120. In at least one embodiment, the wettable needle chamber 1144 is formed from a portion of the nozzle liquid passageway 1124 (e.g., the portion between the nozzle liquid outlet 1126 and a secondary opening 1148/packing seal (not shown). The needle passageway 1140 can intersect the nozzle liquid passageway 1124 proximate to the secondary opening 1148.

In block 608, the user or third-party can seal the secondary opening 1148 within the valved nozzle assembly 1100. The sealing structure 1130 can be positioned between the end of liquid chamber 1128 and tube end 1132. In at least one embodiment, the tube end 1132 can form the secondary opening 1148. In at least one embodiment, the sealing structure 1130 can be installed proximate to or at the original position of the packing seal (which would have been removed to install the sealing structure 1130).

In at least one embodiment, the sealing structure 1130 can be integrally molded with the barrel body 1104. For example, the non-wettable needle chamber 1142 can be completely filled in and no passageway may be formed. Thus, a third-party could provide the sealed nozzle assembly to the user. In at least one embodiment, the sealing structure 1130 can fluidically separate the non-wettable needle chamber 1142 from the wettable needle chamber 1144.

In block 614, a user or third-party can install a resilient flow control valve within the nozzle liquid passageway 1124 or liquid passageway. The resilient flow control valve can be installed between the barrel body 1104 and the liquid nozzle portion 1106. Both the barrel body 1104 and the liquid nozzle portion 1106 can contain features that allow a fluid-tight connection to form.

On a first end 1150, the barrel body 1104 includes the wall 1118, and wall 1116 that are configured to mate with the liquid nozzle portion 1106. The liquid nozzle portion 1106 can have a groove 1136 that is fixedly coupled to a wall 1116 and attachment point 1138 that is fixedly coupled to the wall 1118 such that a fluid-tight seal is formed. The liquid nozzle portion 1106 can also have an edge portion 1146 defining a nozzle sealing surface 1110 of the nozzle liquid passageway 1124. A shaping gas passageway can be established between the wall 1118 and the wall 1116.

The tube end 1134 can be configured to abut the resilient flow control valve 1112 (including the flange 1114). The resilient flow control valve 1112 can be configured to nestle between the tube end 1134 and the edge portion 1146. In at least one embodiment, the flange 1114 of the resilient flow control valve 1112 can abut the edge portion 1146.

Once installed, then the valved nozzle assembly 1100 can be a valved nozzle assembly or valved nozzle cartridge which can be installed on the spray gun platform as described in block 616.

FIG. 12A and FIG. 12B illustrates a nozzle cartridge 1200 that can be used with a spray gun platform. The nozzle cartridge 1200 can be similar in construction to that described by Fox in U.S. Patent Application No. 20110024524 except one end configured to form to the needle chamber is sealed. For example, the nozzle cartridge 1200 can have a nozzle cartridge body 1204 that is compatible with a complementary spray gun platform. The nozzle cartridge body 1204 can have at least two openings formed therein, liquid outlet 1216 and liquid inlet 1226. For example, the liquid outlet 1216 can be where fluid is expelled from the nozzle cartridge body 1204 and liquid inlet 1226 can be an inlet where the nozzle cartridge body 1204 receives a fluid from a source. In operation, air can flow around the exterior surface 1202 of the nozzle cartridge body 1204 while the liquid can flow on the interior surface 1222.

The liquid inlet 1226 can fluidically connect to liquid outlet 1216 via a liquid passageway 1208 formed therein. The liquid passageway 1208 can include various chambers such as liquid chamber 1210, secondary opening 1212, and wettable needle chamber 1230. Liquid can flow from the liquid chamber 1210 into the wettable needle chamber 1230, through the resilient flow control valve 1218, nozzle sealing surface 1224, then the liquid outlet 1216.

In block 614, the resilient flow control valve 1218 can be installed in the liquid passageway 1208 and activate in response to negative pressure from airflow on the exterior surface 1202. In at least one embodiment, the resilient flow control valve 1218 can include a frame structure 1220 that is attachable to the interior surface 1222.

In block 608, the sealing structure 1206 is installed on the tube end 1228 of the nozzle cartridge body 1204. For example, the sealing structure 1206 is shown as a separate part but could also be integrally molded with the tube end 1228 to form a wall (similar to FIG. 8). In at least one embodiment, the secondary opening 1212 is outside the confluence region 1214 of the nozzle cartridge 1200. In at least one embodiment, the sealing structure 1206 can abut one portion of the liquid chamber 1210 such that the secondary opening 1212 does not exist.

FIG. 13 illustrates a nozzle cartridge 1300 that is similar to nozzle cartridge 1200 except that the nozzle cartridge 1300 can have a radial ledge 1314 having openings 1308 formed therein.

For example, the nozzle cartridge 1300 can have a first end 1318 for engagement with an air cap and a second end 1316, opposite the first end 1318, for engagement with a spray gun platform 102. The second end 1316 can have a spur protrusion 1312 for fitment into a particular geometry of a spray gun platform. The radial ledge 1314 can be disposed toward the first end 1318. The nozzle cartridge 1300 can have a liquid passageway 1320 formed within the body of the nozzle cartridge 1300 and a gas passageway 1306 formed on the exterior surface of the nozzle cartridge 1300. In at least one embodiment, the gas can travel across the exterior surface and through the openings 1308.

The liquid passageway 1320 can have a liquid chamber 1304 which receives liquid from a liquid source. The liquid chamber 1304 leads into the needle passageway 1322. The secondary opening 1324 can lead into the needle passageway 1322. In at least one embodiment, the needle passageway 1322 of the nozzle cartridge 1300 can include a sealing structure 1302 to seal the secondary opening 1324 when installed in a spray gun system in block 608.

In at least one embodiment, the resilient flow control valve 1310 can be installed within the liquid passageway 1320 in block 614 (e.g., between the liquid chamber 1304 and the needle passageway 1322). The flow of gas can cause negative pressure at a fluid tip (not shown) and cause liquid to be dispensed through the liquid outlet of the body of the nozzle assembly (not shown).

FIG. 14A and FIG. 14B illustrate a nozzle assembly 1400. The nozzle assembly 1400 can be modified from the nozzle assembly 104 in FIG. 1. For example, while nozzle assembly 1400 can have a nozzle liquid inlet 1410 and an attachment structure 1402 for coupling with the liquid passageway of a corresponding spray gun platform, the nozzle assembly 1400 can have internal nozzle passageways formed therein.

For example, the nozzle assembly 1400 can have a nozzle liquid passageway 1406 formed between nozzle liquid inlet 1410 and liquid outlet 1408 which are coaxial with the spray axis 1420 (and needle passageway 1412). The nozzle liquid passageway 1406 can fluidically couple the liquid outlet 1408 with nozzle liquid inlet 1410. The nozzle liquid passageway 1406 can be aligned with the needle passageway 1412. A nozzle gas passageway 1404 can be formed through the walls of the nozzle assembly 1400 such that flow from the gas can be transported around a portion of the nozzle assembly 1400 and directed through the nozzle gas passageway 1404 (shown as being formed by a plurality of holes formed in the nozzle assembly 1400.

FIG. 14B illustrates the interior cross section of nozzle assembly 1400. For example, the resilient flow control valve 1414 can be placed within the nozzle liquid passageway 1406, but the resilient flow control valve 1414 can be installed in block 614 in a position upstream to the nozzle sealing surface 1424 (which is adjacent the liquid outlet 1408). The resilient flow control valve 1414 can have a slit 1422 formed therein. The slit 1422 can intersect with the spray axis 1420 and is openable as described herein.

The resilient flow control valve 1414 can have an attachment structure 1416 used for securing the resilient flow control valve 1414 against the needle passageway 1412. The attachment structure 1416 can be a flange, lip, ledge, or detent. The attachment structure 1416 is shown as an annular flange and can form a sealing surface 1428 to sealingly engage with portions of needle passageway 1412. The needle passageway 1412 can have a complementary attachment structure 1418 that is configured to mate with the attachment structure 1416 to form a secure mechanical connection between the resilient flow control valve 1414 and the needle passageway 1412. In at least one embodiment, the resilient flow control valve 1414 can be further secured to the needle passageway 1412 using adhesives, ultrasonic welding, overmolding, or other attachment mechanisms. In at least one embodiment, an edge of the attachment structure 1416 and/or the complementary attachment structure 1418 can have adhesive disposed therein. In at least one embodiment, the resilient flow control valve 1414 can divide the needle passageway 1412 into a nozzle sealing surface 1424 (which can be conical) and a chamber 1426.

FIG. 15A and FIG. 15B illustrate another embodiment of a valved fluid nozzle 1500. In at least one embodiment, a kit including a spray gun nozzle body 1504, a resilient flow control valve 1502, and/or a sealing structure (not shown) can be formed. In at least one embodiment, a resilient flow control valve 1502 can be inserted into a spray gun nozzle body 1504 of a spray gun as described in block 614. Examples of resilient flow control valve 1502 can include one-way and two-way valves, duck bill valves, cross valves, and the like. The resilient flow control valve 1502 shown is a duck-bill valve having a single horizontal slit 1508 and a flange 1506.

The flange 1506 can be annular and have a flange diameter that is different than an inner diameter of the resilient flow control valve 1502. The spray gun nozzle body 1504 can have a fluid opening (leading to a second fluid passageway for the liquid). The spray gun nozzle body 1504 can have a rim 1512 that is formed by a wall of the spray gun nozzle body 1504. The rim 1512 can have a rim diameter. In at least one embodiment, a secondary seal 1510 can nestle within the rim diameter to provide a better fitment of the resilient flow control valve 1502. The frame can have a frame diameter that receives the flange 1506. In at least one embodiment, the flange diameter is greater than the frame diameter.

When assembled, the resilient flow control valve 1502 can form a fluid-tight seal with the rim 1512 of the resilient flow control valve 1502. The flange 1506 can act as a sealing surface and sealingly engage with the rim 1512.

FIG. 16 illustrates a modified needle assembly 1600 that can be useful in block 610. In at least one embodiment, the modified needle assembly 1600 can be used to replace a needle in spray gun system 700 when converting a spray gun platform and can have a sealing structure 1608 installed thereon. The modified needle assembly 1600 can include a forward shaft section 1610 and aft shaft section 1614. The modified needle assembly 1600 can have a first end 1602 and a second end 1604. The first end 1602 can be configured to be oriented toward a fluid nozzle of a spray gun and the second end 1604 can be oriented opposite from the first end 1602 and configured to be oriented toward an adjustment knob of a spray gun.

Between the forward shaft section 1610 and aft shaft section 1614 can be a needle boss 1612 for engagement with a biasing mechanism disposed on the second end 1604. The sealing structure 1608 can be disposed on the first end 1602. The sealing structure 1608 can be a setback distance 1606 from the needle boss 1612 and configured to fluidically seal the non-wettable needle chamber from the liquid passageway of a spray gun. The aft shaft section 1614 and needle boss 1612 can be dimensioned similarly to a conventional needle used for the model and manufacture of spray gun platform.

The sealing structure 1608 can be any structure that allows for sealing with the needle chamber. In at least one embodiment, the sealing structure 1608 can be movable in the axial direction with the spray gun system. In at least one embodiment, the sealing structure 1608 can be an expanding seal. An expanding seal can be configured to fit and/or sealingly engage through a first bore of a needle chamber (e.g., secondary opening 154), and expand out to and form a fluid-tight seal a larger bore size in the wettable needle chamber. The expanding seal can maintain a fluid-tight seal while undergoing axial motion. Examples of expanding seals can include umbrella seals, piston seals, plunger seals, or combinations thereof. In at least one embodiment, the sealing structure 1608 can include a packing seal, or a poppet seal such that the forward shaft section 1610 is movable against it while maintaining a fluid-tight seal.

FIG. 17 illustrates a modified needle assembly 1700 that is similar to modified needle assembly 1600 except that modified needle assembly 1700 does not include a sealing structure for sealing directly against the wettable needle chamber. For example, the modified needle assembly 1700 can be configured to seal against an inner diameter of a packing seal. Thus, the forward shaft section 1610 can be slidably sealed against the packing seal, and both the forward shaft section 1610 and the packing seal form a sealing structure at the secondary opening.

The first end 1704 can be different from the first end 1602 in that there is no sealing structure present (which can change the dimension 1702). The modified needle assembly 1700 can have a dimension 1702 such that a needle-nozzle seal is not formable when the trigger is in an inactivated position. For example, dimension 1702 can be less than dimension 320 if the modified needle assembly 1700 is configured to sealingly engage within the spray gun platform 300 of FIG. 3. Although shown as having a blunted end, both the modified needle assembly 1600 and modified needle assembly 1700 may have a pointed needle tip.

Modified needle assembly 1700 can be configured to work with an existing poppet valve in the spray gun platform. For example, a poppet valve can include a poppet inner diameter and a poppet outer seal. In at least one embodiment, the modified needle assembly 1700 is configured to form a slidable fluid-tight seal with the poppet inner diameter of the poppet valve.

“Across” refers to between two opposing major surfaces. For example, between an upstream side and a downstream side of a resilient flow control valve.

“Actuator” refers to a device or mechanism that is configured to manually control a gas valve from outside a gas valve body and/or outside of a spray gun body, or a spray gun component body. The term actuator can also include a button or a trigger structure.

“Atmosphere” refers to environmental conditions (atmospheric pressure, temperature, etc.) surrounding the spray gun system.

“Atmospheric pressure” refers to pressure exerted by the atmosphere on the spray gun system. “Body” refers to a material form of an object.

“Closed” refers to a state of the resilient flow control valve in which no liquid flows when liquid is on an upstream side of the resilient flow control valve.

“Closed configuration” refers to a configuration of the resilient flow control valve that does not allow passage of a liquid from the upstream side of the resilient flow control valve to a downstream side when liquid is present on the upstream side. Closed configuration can include an unopened slit(s) or self-sealing flaps within the resilient portion.

“Closing pressure” refers to the pressure at or below which a resilient flow control valve with transition from an open configuration to a closed configuration. The closing pressure and the opening pressure can be different values.

“Conventional needle” refers to a needle having a needle tip configured to form a needle-nozzle seal with a nozzle sealing surface. An adjustment knob or other portion of the spray gun platform can form an end stop for the conventional needle.

“Differential pressure” refers to a difference in pressure between an upstream (P1) and downstream (P2) location. It can be expressed as ΔP=P1−P2.

“Downstream liquid chamber” refers to a chamber that is downstream from the resilient flow control valve. The downstream liquid chamber can be configured to facilitate negative fluid pressure in response to positive fluid flow in the gas passageway.

“Downstream side” refers to a side that is downstream from a resilient portion.

“Elastomeric” refers to natural or synthetic polymers, such as natural or synthetic rubber, that display viscoelastic behavior under deformation, have a low modulus of elasticity (e.g., no greater than 0.5 GPa), and a high failure strain.

“Fluid-tight” refers to prohibiting the entrance of fluids such as water at appropriate operating pressures of a spray gun system. In at least one embodiment, the liquid can be at pressures no greater than 50 pounds per inch.

“Gas” refers to a substance or matter in a state in which it will expand freely to fill the whole of a container, having no fixed shape (unlike a solid) and no fixed volume (unlike a liquid). The gas can be used in a spraying process to atomize a bulk liquid and form a spray pattern. The gas can be used as a carrier for the liquid to assist in delivery of the fluid. Examples of gases include nitrogen, carbon dioxide, gas mixtures such as air, and even gas propellants which may be in a gaseous state at standard state conditions but liquified at higher pressures.

“Gas valve” refers to a device to control, direct, or regulate flow of the gas (and can indirectly control, direct, or regulate flow of the liquid by changing the differential pressure across a resilient flow control valve described herein) in a binary or graduated manner. Examples of a gas valve can include gate valves, poppet valves, butterfly valves, ball valves and the like.

“Grip portion” refers to a section that is configured to be gripped by a user's hand.

“Linear” refers to arranged in or extending along a straight or nearly straight line.

“Liquid” refers to coating materials that can be applied to a surface using a spray gun system including (without limitation) paints, primers, base coats, lacquers, varnishes and similar paint-like materials as well as other materials such as adhesives, sealers, fillers, putties, powder coatings, blasting powders, abrasive slurries, mold release agents and foundry dressings which may be applied in atomized or non-atomized form depending on the properties and/or the intended application of the material. In these applications, the term liquid is used generically as it may include solid particles (pigments, powders, granules, etc.) which are suspended or dissolved in a carrier liquid.

“Liquid outlet” refers to a location where a liquid exits a spray gun component, or would exit the spray gun component without interference from a resilient flow control valve. For example, the resilient flow control valve can be installed on the liquid outlet of a spray gun component and form a portion of the liquid outlet. In at least one embodiment, the liquid outlet can be at least partially formed at a distal end of a spray gun component.

“Liquid passageway” refers to a liquid flow path within the spray gun component body.

“Liquid reservoir component” refers to a component within a liquid reservoir system. Examples of liquid reservoir components include lids, containers, cups, pouches, bags, adapters, and liquid hose assemblies.

“Liquid reservoir system” refers to a system configured to hold or transport a liquid. The liquid reservoir system can include at least a liquid reservoir component. The liquid reservoir system can include a plurality of liquid reservoir components such as a cup, and a lid. The liquid reservoir system can also include components such as liquid hose assemblies that are fluidically coupled to a drum. The liquid reservoir system can be a type of liquid source.

“Manually-operated valve” refers to a valve capable of being controlled via a mechanical linkage to an actuator. For example, the manually-operated valve can be mechanically coupled to another component such as a trigger of a spray gun platform. The manually-operated valve can translate along the spray longitudinal axis. Examples of manually-operated valves include poppet, globe valve, gate valve, ball valve, butterfly valve, plug valve, slide valve, a needle valve, a lever, or a pinch-valve. The term “manually-operated valve” excludes the resilient flow control valve. For example, even though a slit in a resilient portion can be pushed with manual pressure, the resilient flow control valve is not a “manually-operated valve” because the primary and/or intended mechanism is based on differential pressure, not manual activity.

“Mixing zone” refers to where a stream of gas exits a gas outlet and merges, interacts with, intersects, and/or atomizes a stream of liquid from a liquid outlet.

“Needle chamber” refers to the wettable needle chamber, the non-wettable needle chamber, or a discrete portion of the needle passageway.

“Needle passageway” refers to a passageway formed within a spray gun system (including the nozzle assembly and spray gun platform) configured to receive a conventional needle and related components such as biasing mechanisms. At a first end, the needle passageway can include the nozzle sealing surface. At a second end, the needle passageway can include an opening that is sealable by an adjustable knob.

“Nozzle assembly” refers to a fluid nozzle and a device for coupling the fluid nozzle to a spray gun platform. The nozzle assembly acts to transport a gas through a gas passageway and/or transport a liquid through a liquid passageway formed therein. The gas passageway and/or the liquid passageway of the nozzle assembly is mateable with the gas passageway and/or the liquid passageway of the spray gun platform. In at least one embodiment, the nozzle assembly can include a nozzle cartridge.

“Nozzle cartridge” refers to a spray gun component having a liquid passageway for direct connection to a liquid source/liquid reservoir system and a liquid outlet. When combined with a spray gun platform, the spray gun platform itself does not include the liquid passageway but the spray gun platform can include a portion of a gas passageway for connection to the gas source. Nozzle cartridge can refer to a type of nozzle assembly.

“Open” refers to any state that allows some liquid to flow across a resilient flow control valve when liquid is present on the upstream side. For example, open can refer to partially-open.

“Open configuration” refers to a configuration that allows passage of a liquid from the upstream side to the downstream side when liquid is present at the upstream side.

“Opening dimension” refers to the largest dimension of an opening of the resilient flow control valve.

“Opening pressure” refers to a differential pressure capable of opening a resilient portion of a resilient flow control valve. Opening pressure is synonymous with cracking pressure.

“Resilient” refers to a material's ability to absorb energy upon elastic deformation, and release that energy upon unloading. Upon unloading, the material will return to its initial state. Elastomeric materials can be resilient.

“Resilient flow control valve” refers to a valve that operably controls the flow of a liquid having the ability to adjust its degree of openness based upon variations in differential pressure, and the resiliency to remain in a normally-closed configuration once a pre-determined closing differential pressure is achieved. The term “resilient flow control valve” can be used to refer to the resilient portion or any component of the resilient flow control valve.

“Resilient portion” refers to a portion of the resilient flow control valve that controls flow of a fluid. The resilient portion is configured to change between an open configuration and a closed configuration based on a differential pressure across the resilient portion relative to an opening pressure of the resilient portion. The resilient portion can be elastomeric but may utilize rigid or semi-rigid layers.

“Rigid” is used to refer to materials that are not easily deformed/flexible. In one example, rigid materials can be described as having a “stiffness”, or a modulus of elasticity of at least 0.5 GPa.

“Sealing structure” refers to elements or structures that seal a needle chamber (e.g., wettable, or non-wettable) or other part of the spray gun from the environment. The sealing structure can be liquid-tight such that liquid does not travel into or out from the needle chamber. Sealing structures can include plugs, stoppers, walls, welds, injection molded parts, etc.

“Sealingly engage” refers to a surface (i.e., a sealing surface) of a first body forming a fluid-tight seal with a surface of a second body, either directly or indirectly (e.g., through another structure like a packing seal or frame structure).

If the first body is a resilient flow control valve having a sealing surface and the second body is a nozzle liquid passageway having an interior bore surface, then the sealing surface of the resilient flow control valve can form a fluid-tight seal with the interior bore of the nozzle liquid passageway.

The term “sealingly engage” can refer to a sealing surface on a periphery of the first or second body and not the first or second body being fluid-tight as a whole. For example, the resilient flow control valve may have a slit or opening which can open in response to differential pressure but is not fluid-tight under certain circumstances.

“Spray equipment” refers to any equipment or component that is used to convey, store, or atomize bulk fluids into a fine spray or mist of droplets. Spray equipment can refer to devices that use air spray, airless, rotary/centrifugal, ultrasonic, or electrostatic methods.

“Spray gun” refers to a type of spray equipment. Spray gun can refer to an air spray gun that uses a low-pressure liquid stream mixed with compressed gas to atomize the liquid in a controlled manner.

“Spray gun component” refers to a component that forms part of a spray gun system. Examples of spray gun components include a spray gun platform, valve, nozzle assembly, nozzle cartridge, air cap, liquid reservoir system and liquid reservoir components thereof. The spray gun component can also include any device that physically attaches to any of the aforementioned spray gun components.

“Spray gun platform” refers to a spray gun component that has a grip portion, actuator, and connections to the gas source and optionally a liquid reservoir system. In at least one embodiment, the spray gun platform may refer to a spray gun body with an integrated liquid inlet. In at least one embodiment, the spray gun platform can manually couple to a nozzle cartridge or nozzle assembly.

“Spray gun system” refers to one or more spray gun components that, when assembled together, are configured to atomize a liquid and/or shape it into a spray. The spray gun system can use air to atomize a liquid. The spray gun can be a manual spray gun system or can be robotic, meaning attached to a robotic arm.

“Tapered region” refers to a region that is tapering from a first dimension to a second dimension. The second dimension is less than the first dimension. Dimensions can include a diameter, or perimeter and can be generally indicative of bore or opening size.

“Tubular” refers to a long, round, and hollow shape. Tubular can refer to an ellipsoidal, polygonal cross-section.

“Upstream side” refers to a side that is upstream from a resilient portion.

1. A modified needle assembly comprising:
a first shaft section having a first end, wherein the first end is configured to be oriented toward a nozzle sealing surface of a spray gun system;
a second shaft section having a second end opposite the first end, wherein the second shaft section is configured to sealingly engage in a non-wettable needle chamber of the spray gun system;
wherein the second end is configured to operably engage with components of the spray gun system and the first end is not configured to contact the nozzle sealing surface to form a needle-nozzle seal; and
wherein the modified needle assembly has a needle length dimension that is less than a length dimension of a needle passageway of the spray gun system.

2. The modified needle assembly of claim 1, wherein the first shaft section has a length dimension that is less than a conventional needle for the spray gun system, wherein the first end is configured not to form a fluid-tight seal with the spray gun system.

3. The modified needle assembly of claim 1, wherein the second shaft section is configured to form a slidable fluid-tight seal with a packing seal.

4. The modified needle assembly of claim 1, wherein the first shaft section is configured to form a fluid-tight seal with a poppet valve, the poppet valve seals the non-wettable needle chamber and engages with a trigger of the spray gun system, wherein the poppet valve comprises a thru passageway from a poppet flange end to a poppet distal end.

5. The modified needle assembly of claim 1, further comprising a sealing structure disposed on the first end of the first shaft section, wherein the sealing structure is configured to form a fluid-tight seal with a portion of the needle passageway to separate the needle passageway into a wettable needle chamber and the non-wettable needle chamber.

6. The modified needle assembly of claim 5, wherein the second shaft section is configured to engage with a biasing mechanism.

7. A kit, comprising:
a resilient flow control valve configured to sealingly engage within a portion of a nozzle liquid passageway of a nozzle assembly or directly adjacent to the nozzle liquid passageway, the nozzle assembly comprising:
a nozzle gas inlet and a nozzle gas outlet forming an atomizing gas passageway therebetween; and
a nozzle liquid inlet and a nozzle liquid outlet forming the nozzle liquid passageway therebetween;
wherein the atomizing gas passageway is configured to be removably coupled to a gas passageway of a spray gun platform,
wherein the nozzle liquid passageway is configured to form a fluid-tight seal with a needle of the spray gun platform at a needle-nozzle seal of the nozzle assembly.

8. The kit of claim 7, wherein the nozzle assembly comprises an attachment structure on an outside surface configured to mate with a compatible attachment structure on the spray gun platform.

9. The kit of claim 8, further comprising the spray gun platform, wherein a spray gun system comprises the spray gun platform and the nozzle assembly, wherein the spray gun system comprises a needle passageway configured to allow a conventional needle to pass through both the spray gun platform and the nozzle assembly, wherein the portion of the nozzle liquid passageway is coaxial with the needle passageway.

10. The kit of claim 9, wherein the nozzle liquid passageway is configured to be removably coupled to a liquid passageway of the spray gun platform at a second end opposite from the needle-nozzle seal.

11. The kit of claim 7, wherein, when the nozzle assembly is assembled with the spray gun platform and operating in a first mode, a differential pressure across the resilient flow control valve is less than an opening pressure of the resilient flow control valve and results in a closed configuration;
wherein, in a second mode, gas flow from a spray gun system including the spray gun platform and the nozzle assembly causes the differential pressure across the resilient flow control valve to be at least the opening pressure of the resilient flow control valve and thereby causes the resilient flow control valve to change to an open configuration.

12. The kit of claim 11, wherein the resilient flow control valve comprises a slit that is capable of forming an opening in the open configuration.

13. The kit of claim 7, wherein the nozzle assembly is a nozzle cartridge, wherein the nozzle liquid passageway is formed between the nozzle liquid inlet, and the nozzle liquid outlet, and a wettable needle chamber is formed from a portion of the nozzle liquid passageway and between the nozzle liquid outlet and a secondary opening of the spray gun system.

14. The kit of claim 7, further comprising a poppet valve that is configured to (1) not allow the needle to pass thru, (2) slidably seal a non-wettable needle chamber, and (3) engage with a trigger of the spray gun platform;
wherein the spray gun platform comprises the non-wettable needle chamber formed therein.

15. The kit of claim 7, further comprising a modified needle assembly comprising:
a first shaft section having a first end, wherein the first end is configured to be oriented toward a nozzle sealing surface of a spray gun system;
a second shaft section having a second end opposite the first end, wherein the second shaft section is configured to sealingly engage in a non-wettable needle chamber of the spray gun system;
wherein the second end is configured to operably engage with components of the spray gun system and the first end is not configured to contact the nozzle sealing surface to form a needle-nozzle seal; and
wherein the modified needle assembly has a needle length dimension that is less than a length dimension of a needle passageway of the spray gun system.

16. A method, comprising:
installing a resilient flow control valve within a portion of a liquid passageway formed in a spray gun system such that liquid is capable of being contained by the resilient flow control valve without leakage of liquid from a liquid outlet of the spray gun system, wherein a wettable needle chamber is coaxial with the portion of the liquid passageway.

17. The method of claim 16, further comprising: sealing a secondary opening of a needle passageway formed in the spray gun system comprising a spray gun platform and a nozzle assembly, wherein the needle passageway is configured to allow a conventional needle to pass through both the spray gun platform and nozzle assembly, wherein the sealing forms the wettable needle chamber and a non-wettable needle chamber from the needle passageway, wherein sealing the secondary opening does not use the conventional needle, wherein no leakage occurs through the secondary opening as a result of the sealing.

18. The method of claim 16, further comprising: removing a conventional needle from a needle passageway comprising the wettable needle chamber.

19. The method of claim 18, further comprising: installing a modified needle assembly comprising:
a first shaft section having a first end, wherein the first end is configured to be oriented toward a nozzle sealing surface of a spray gun system;
a second shaft section having a second end opposite the first end, wherein the second shaft section is configured to sealingly engage in a non-wettable needle chamber of the spray gun system;
wherein the second end is configured to operably engage with components of the spray gun system and the first end is not configured to contact the nozzle sealing surface to form a needle-nozzle seal; and
wherein the modified needle assembly has a needle length dimension that is less than a length dimension of a needle passageway of the spray gun system.

20. The method of claim 19, wherein the modified needle assembly does not form a needle-nozzle seal with the spray gun system, wherein a first end of modified needle assembly is at least 0.5 mm, or a dimension of the resilient flow control valve, from the resilient flow control valve when installed.
